(19) United States
(12) Patent Application Publication
(10) Pub. No.: US 2007/0007495 A1
(43) Pub. Date: Jan. 11, 2007

(54) Electrically conductive polyetherester composition comprising carbon black and product made therefrom

(76) Inventor: Richard Allen Hayes, Brentwood, TN (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/155,976

(22) Filed: Jun. 17, 2005

Related U.S. Application Data
(60) Provisional application No. 60/580,944, filed on Jun. 18, 2004.

(51) Int. Cl. H01B 1/12

(52) U.S. Cl. 252/500

(57) ABSTRACT

A composition comprising a carbon black-containing polyetherester is disclosed. The carbon black-containing polyetherester comprises or consists essentially of ≦about 3.5 weight % of carbon black if the carbon black has a DBP of >about 420 cc/100 g, or ≦about 15 weight % of carbon black if the carbon black has a DBP between about 220 cc/100 g and about 420 cc/100 g or between about 150 cc/100 g and about 210 cc/100 g wherein the carbon black has a nitrogen adsorption surface area measure by ASTM D 3037-81>700 m²/g. Also disclosed are a process for producing the composition and a shaped article made from the composition.

The invention claims the priority to U.S. provisional application Ser. No. 60/580944, filed Jun. 18, 2004, the entire disclosure of which is incorporated herein by reference.

The present invention relates to an electrically conductive composition polyetherester comprising carbon black, to a process therefor, and to an article produced therefrom.

### BACKGROUND OF THE INVENTION

Carbon black filled polymers are typically classified within the art through their electrical characteristics into three categories: antistatic, static dissipating or moderately conductive, and conductive. Conductive materials are generally defined as having surface resistivities below 100,000 Ohms/square. Such materials do not generate a charge or allow a charge to remain localized on a part's surface and can ground a charge quickly or shield parts from electromagnetic fields. See, e.g., U.S. Pat. No. 6,540,945 and U.S. Pat. No. 6,545,081.

A conductive carbon black can be dispersed within an insulating polymer matrix. As the amount of dispersed carbon black particles is increased and reaches the “percolation threshold” concentration, the conductive particles come sufficiently into contact with each other so that a marked increase in conductivity is evidenced. The desired electrical properties are tailored by controlling the level of the conductive carbon black.

Known electrically conductive polyester compositions have high carbon black loadings diminishing other desired properties. See, e.g., JP61000256A2, U.S. Pat. No. 3,803,453, U.S. Pat. No. 4,559,164, JP01022367, JP61000256, JP3327426 B2, U.S. Pat. No. 5,262,470, U.S. Pat. No. 5,484,838, U.S. Pat. No. 5,643,991, U.S. Pat. No. 5,698,148, U.S. Pat. No. 5,776,608, U.S. Pat. No. 5,952,099, U.S. Pat. No. 5,726,283, U.S. Pat. No. 5,916,506, U.S. Pat. No. 6,242,094, JP06340799A2, U.S. Pat. No. 6,096,818, U.S. Pat. No. 6,291,567, U.S. Pat. No. 6,139,943, U.S. Pat. No. 6,174,427, U.S. Pat. No. 6,331,586, and EP1277807A2.

Carbon black has been incorporated within polyetherester compositions to improve the electrical properties. See, e.g., U.S. Pat. No. 4,351,745, U.S. Pat. No. 4,610,925, U.S. Pat. No. 4,610,925, and JP50133243.

Carbon black, which is difficult to disperse into a polyester matrix, can enhance the melt viscosity of the carbon black-filled polyester composition. Such composition may be overworked at high shear and temperature conditions, causing the resins to degrade and lose a portion of their valued physical and thermal properties. The high melt viscosity of the carbon black-filled polyester composition may complicate production processes to produce useful shaped articles, such as monofilaments, textile fibers, films, sheets, molded parts, and the like. Shaped articles produced from the carbon-black-filled polyester compositions may suffer from deteriorated properties. See, e.g., U.S. Pat. No. 3,969,559, U.S. Pat. No. 4,255,487, U.S. Pat. No. 5,952,099, U.S. Pat. No. 6,037,395, U.S. Pat. No. 6,139,943, and U.S. Pat. No. 6,331,586.

The advent of highly conductive carbon black fillers, which incorporate high structure with high surface areas, has not overcome these shortcomings. Although they allow for a reduction in the level of carbon black to achieve the desired electrical properties, the high structure and the high surface area properties of said carbon black materials actually effects the melt viscosity of the polyester compositions to a much greater extent than the carbon black materials they replaced. See, for example, U.S. Pat. No. 6,331,586, U.S. Pat. No. 6,441,084, and EP1277807A2.

Reduction of the level of these highly conductive carbon black fillers to avoid the above-mentioned shortcomings has not been disclosed to provide the desired electrical properties. In fact, U.S. Pat. No. 6,037,395 discloses against the use of <about 5 weight % of a conductive carbon black, including Ketjenblack EC 600 JD carbon black, in certain polycarbonate/polyester blends produced through a melt mixing process due to low conductivity, (U.S. Pat. No. 6,037,395). See also U.S. Pat. No. 6,096,818, U.S. Pat. No. 6,291,567, U.S. Pat. No. 6,331,586, and U.S. Pat. No. 6,096,818 (all teaches against the use of low levels conductive carbon black).

The addition of carbon black within a polyester polymerization medium to tint the polyester composition has been disclosed. See, e.g., JP02043764, JP08026137, JP45023029, JP48056251, JP48056252, JP49087792, JP50037849, JP51029898, JP51029899, JP55066922, JP57041502, JP58030414, JP59071357, U.S. Pat. No. 3,275,590, U.S. Pat. No. 4,408,004, U.S. Pat. No. 4,476,272, U.S. Pat. No. 4,535,118, U.S. Pat. No. 5,925,710, U.S. Pat. No. 6,503,586, and DE10118704.

Therefore, there is a need to develop a polyetherester composition comprising a low level of carbon black and a process to produce and the composition thereby having the desired electrical properties without unduly deteriorating the other valued melt viscosity, processing, and shaped article properties. Reducing the level of carbon black within a polyetherester composition, impact modifiers and tougheners, which are typically required when high levels of carbon black are used, may be reduced in level or eliminated. The melt viscosity of the polyetherester composition is relatively maintained through the addition of low levels of conductive carbon black materials, providing ease of processing. Conductive polyetherester compositions incorporating low levels of conductive carbon black materials may minimize the carbon black sloughing and rubbing off during processing, such as molding operations, and in the final product produced.

### SUMMARY OF THE INVENTION

The invention includes a composition, having the desired properties including electrical properties, comprising or consisting essentially of carbon black-containing polyetherester, which comprises ≦about 3.5, about 0.5 to about 3.5, or about 1 to about 3.5, weight % of carbon blacks having a DBP (dibutyl phthalate oil adsorption) >about 420 cc/100 g.

The composition can comprise ≦about 15, about 1 to about 10, or about 2 to about 10, weight % of carbon blacks having a DBP between about 220 cc/100 g and about 420 cc/100 g.

The composition can also comprise ≦about 15, about 2 to about 12.5 or about 6 to about 10, weight % of carbon blacks having a DBP between about 150 cc/100 g and about 210 cc/100 g.

The composition can also comprise a combination of carbon black particles including two or more of (a) about 0.1 to about 3.5, about 0.5 to about 3, or about 0.5 to about 2, weight % carbon black having a DBP>about 420 cc/100 g, (b) about 0.1 to about 10, about 0.5 to about 7.5, or about 0.5 to about 5, carbon black having a DBP between about 220 cc/100 g and about 420 cc/100 g, and (c) about 1 to about 12.5, about 2 to about 10, or about 2 to about 7.5 carbon black having a DBP between about 150 cc/100 g and about 210 cc/g, the products produced thereby, and shaped articles formed from said products. Preferably the total level of carbon black (a), (b), and/or (c) is about 1 to about 15, about 1.5 to about 12.5, or about 2 to about 7.5, weight % based on the weight of the polyetherester composition.

The invention also includes a shaped article comprising or produced from the composition.

The invention also include a process comprising or consisting essentially of contacting a mixture with carbon black wherein the mixture comprises at least one dicarboxylic acid, at least one glycol, and at least one poly(alkylene ether)glycol; the carbon black is present in less than 3.5 weight % of the mixture; and the carbon black has a dibutyl phthalate oil adsorption by ASTM D2414-93>420 cc/100 g. The process can produce the polyetherester composition with improved electrical properties, which can be recovered.

### DETAILED DESCRIPTION OF THE INVENTION

Particle size, particle structure, porosity, or volatile content of conductive carbon black filler may influence conductivity. The preferred conductive carbon blacks have a small particle size to provide more particles per unit volume for reducing the interparticle distance. Such carbon blacks may also have a high structure to increase the conductive path through which the electrons travel as they traverse through the carbon. Wishing not to be bound by theory, with high structure, the number of insulative gaps is reduced and the electrons travel through the carbon black with less resistance, providing a more conductive carbon black. It is also more preferable to have a carbon black with a high porosity to yield more particles per unit weight when compared to less porous particles because more porous carbon blacks may serve to further decrease the interparticle distance, providing higher conductivity results. Also preferred is low volatile content carbon black for promoting electron tunneling through the carbon black and, in turn, higher conductivity.

The conductive carbon black fillers are defined herein by their structure, as defined by dibutyl phthalate absorption. Dibutyl phthalate absorption is measured according to ASTM Method Number D2414-93. The DBP has been related to the structure of carbon blacks within the art. High structure carbon blacks typically also have high surface areas. The surface areas of carbon blacks may be measured by ASTM Method Number D3037-81. This method measures the nitrogen adsorption, (BET), of the carbon black.

A carbon black-containing polyetherester composition with the desired properties, such as electrical properties, may incorporate ≦about 3.5, from about 0.5 to about 3.5, or from about 1.0 to about 3.5, weight % of carbon blacks having a DBP>about 420 cc/100 g. At the low ppm levels, (5-25 ppm), the carbon blacks may serve as reheat catalysts for preforms within the melt blown molding processes to produce containers, such as soda bottles. At the intermediate levels, for example between 0.05 and 0.5 weight %, based on the total composition weight, the carbon blacks may serve as potent nucleation agents to enhance the rate of crystallization of certain polyetherester compositions.

The carbon black component can have a DBP absorption of >about 420 cc/100 g and a nitrogen adsorption surface areas >about 1000 m²/g. A commercial example of such a carbon black component suitable within the present invention is Ketjenblack® EC 600 JD carbon black available from the Akzo Company having a DBP absorption of between 480 and 520 cc/100 g and a nitrogen adsorption between 1250 and 1270 m²/g. The level of the carbon black material to be incorporated into the polyetherester compositions of the present invention allow for the entire range of electrical properties desired; antistatic, static dissipating or moderately conductive, and conductive. The carbon black component incorporated can be ≦about 3.5, between about 0.5 to about 3.5, or between about 1.0 to about 3.5 weight %, based on enhanced electrical properties and reduced resin melt viscosity.

Commercial examples of carbon black having a DBP>about 420 cc/100 g and a nitrogen adsorption surface areas >about 1000 m²/g include those available from the Akzo Company such as Ketjenblack® EC 600 JD The Ketjenblack® EC 600 JD carbon black (DBP between 480 and 520 cc/100 g and BET between 1250 and 1270 m²/g).

Commercial examples of carbon black having a DBP between about 220 cc/100 g and about 420 cc/100 g and a nitrogen adsorption surface areas >about 700 m²/g include those available from the Akzo Company such as Ketjenblack® EC 300 J carbon black (DBP between 350 and 385 cc/100 g and nitrogen adsorption of 800 m²/g), Black Pearls® 2000 carbon black (DBP absorption of 330 cc/100 g and BET of between 1475 and 1635 m²/g), and Printex® XE-2 carbon black (DBP absorption between 380 and 400 cc/100 g and nitrogen adsorption of 1300 m²/g).

Commercial examples of carbon black having a DBP between about 150 cc/100 g and about 210 cc/100 g and a nitrogen adsorption surface areas >about 200 m²/g include those available from the Columbian Company (Conductex® 975, DBP 170 cc/100 g and BET 250 m²/g) Cabot Corporation (Vulcan® XC-72, DBP between 78 and 192 cc/100 g and nitrogen adsorption 245 m²/g).

Polyetherester comprises or consists essentially of repeat units derived from a dicarboxylic acid, a glycol, a poly(alkylene ether)glycol, and optionally, a polyfunctional branching agent component.

Dicarboxylic acid component can include unsubstituted, substituted, linear, and branched dicarboxylic acids, the lower alkyl esters of dicarboxylic acids having from 2 carbons to 36 carbons, and bisglycolate esters of dicarboxylic acids. Examples of dicarboxylic acid include terephthalic acid, dimethyl terephthalate, isophthalic acid, dimethyl isophthalate, 2,6-naphthalene dicarboxylic acid, dimethyl-2,6-naphthalate, 2,7-naphthalene dicarboxylic acid, dimethyl-2,7-naphthalate, metal salts of 5-sulfoisophthalic acid, sodium dimethyl-5-sulfoisophthalate, lithium dimethyl-5-sulfoisophthalate, 3,4′-diphenyl ether dicarboxylic acid, dimethyl-3,4′diphenyl ether dicarboxylate, 4,4′-diphenyl ether dicarboxylic acid, dimethyl-4,4′-diphenyl ether dicarboxylate, 3,4′-diphenyl sulfide dicarboxylic acid, dimethyl-3,4′-diphenyl sulfide dicarboxylate, 4,4′-diphenyl sulfide dicarboxylic acid, dimethyl-4,4′-diphenyl sulfide dicarboxylate, 3,4′-diphenyl sulfone dicarboxylic acid, dimethyl-3,4′-diphenyl sulfone dicarboxylate, 4,4′-diphenyl sulfone dicarboxylic acid, dimethyl-4,4′-diphenyl sulfone dicarboxylate, 3,4′-benzophenonedicarboxylic acid, dimethyl-3,4′-benzophenonedicarboxylate, 4,4′-benzophenonedicarboxylic acid, dimethyl-4,4′-benzophenonedicarboxylate, 1,4-naphthalene dicarboxylic acid, dimethyl-1,4-naphthalate, 4,4′-methylene bis(benzoic acid), dimethyl-4,4′-methylenebis(benzoate), bis(2-hydroxyethyl)terephthalate, bis(2-hydroxyethyl)isophthalate, bis(3-hydroxypropyl)terephthalate, bis(3-hydroxypropyl)isophthalate, bis(4-hydroxybutyl)terephthalate, bis(4-hydroxybutyl)isophthalate, oxalic acid, dimethyl oxalate, malonic acid, dimethyl malonate, succinic acid, dimethyl succinate, methylsuccinc acid, glutaric acid, dimethyl glutarate, 2-methylglutaric acid, 3-methylglutaric acid, adipic acid, dimethyl adipate, 3-methyladipic acid, 2,2,5,5-tetramethylhexanedioic acid, pimelic acid, suberic acid, azelaic acid, dimethyl azelate, sebacic acid, 1,11-undecanedicarboxylic acid, 1,10-decanedicarboxylic acid, undecanedioic acid, 1,12-dodecanedicarboxylic acid, hexadecanedioic acid, docosanedioic acid, tetracosanedioic acid, dimer acid, bis(2-hydroxyethyl)glutarate, bis(3-hydroxypropyl)glutarate, bis(4-hydroxybutyl)glutarate), and the like and mixtures derived therefrom.

Preferably, the dicarboxylic acid is an aromatic dicarboxylic acid such as terephthalic acid, dimethyl terephthalate, bis(2-hydroxyethyl)terephthalate, bis(3-hydroxypropyl)terephthalate, bis(4-hydroxybutyl)terephthalate, isophthalic acid, dimethyl isophthalate, bis(2-hydroxyethyl)isophthalate, bis(3-hydroxypropyl)isophthalate, bis(4-hydroxybutyl)isophthalate, 2,6-naphthalene dicarboxylic acid, dimethyl-2,6-naphthalate, and mixtures derived therefrom. Essentially any dicarboxylic acid known in the art may find utility within the present invention. A dicarboxylic acid component can be incorporated into the polyetherester at a level between about 90 and about 110, about 95 and about 105, or about 97.5 and about 102.5, mole % based on 200 mole % of the total of the dicarboxylic acid component, the poly(alkylene ether)glycol component, and the glycol component.

A glycol can include unsubstituted, substituted, straight chain, branched, cyclic aliphatic, aliphatic-aromatic or aromatic diols having from 2 carbon atoms to 36 carbon atoms. Specific examples of the desirable glycol component include ethylene glycol, 1,3-propanediol, 1,4-butanediol, 1,6-hexanediol, 1,8-octanediol, 1,10-decanediol, 1,12-dodecanediol, 1,14-tetradecanediol, 1,16-hexadecanediol, dimer diol, 4,8-bis(hydroxymethyl)-tricyclo[5.2.1.0/2.6]decane, 1,4-cyclohexanedimethanol, isosorbide, di(ethylene glycol), tri(ethylene glycol), and the like and mixtures derived therefrom. Essentially any glycol known within the art may find use within the present invention. The glycol component can be incorporated into the polyetherester composition at a level between about 50.0 and about 99.99, about 75.0 and about 99.9, or about 75.0 and about 99.0, mole % based on 100 mole % of the total of the poly(alkylene ether)glycol component and the glycol component.

A poly(alkylene ether)glycol preferably has a molecular weight in the range of about 500 to about 4000. Specific examples of the poly(alkylene ether)glycol component include poly(ethylene glycol), poly(1,3-propylene glycol), poly(1,4-butylene glycol), (polytetrahydrofuran), poly(pentamethylene glycol), poly(hexamethylene glycol), poly(hepthamethylene glycol), poly(ethylene glycol)-block-poly(propylene glycol)-block-poly(ethylene glycol), 4,4′-isopropylidenediphenol ethoxylate (Bisphenol A ethoxylate), 4,4′-(1-phenylethylidene)bisphenol ethoxylate (Bisphenol AP ethoxylate), 4,4′-ethylidenebisphenol ethoxylate (Bisphenol E ethoxylate), bis(4-hydroxyphenyl)methane ethoxylate (Bisphenol F ethoxylate), 4,4′-(1,3-phenylenediisopropylidene)bisphenol ethoxylate (Bisphenol M ethoxylate), 4,4′-(1,4-phenylenediisopropylidene)bisphenol ethoxylate (Bisphenol P ethoxylate), 4,4′sulfonyldiphenol ethoxylate (Bisphenol S ethoxylate), 4,4′-cyclohexylidenebisphenol ethoxylate (Bisphenol Z ethoxylate), and mixtures derived therefrom. However, essentially any poly(alkylene ether)glycol known can be used. The poly(alkylene ether)glycol can be incorporated into the polyetherester composition at a level between about 0.01 and about 50.0, about 0.1 and about 25.0, or about 1.0 and about 25.0, mole % based on 100 mole % of the total of the poly(alkylene ether)glycol component and the glycol component. The sum of the glycol component and poly(alkylene ether)glycol component is incorporated into the polyetherester composition at a level between about 90 and about 110, about 95 and about 105, about 97.5 and about 102.5, or about 100, mole % based on 200 mole % of the total of the dicarboxylic acid component, the poly(alkylene ether)glycol component, and the glycol component.

The optional polyfunctional branching agent component can include any material with three or more carboxylic acid functions, hydroxy functions or a mixture thereof. Specific examples of the desirable polyfunctional branching agent component include 1,2,4-benzenetricarboxylic acid, (trimellitic acid), trimethyl-1,2,4-benzenetricarboxylate, 1,2,4-benzenetricarboxylic anhydride, (trimellitic anhydride), 1,3,5-benzenetricarboxylic acid, 1,2,4,5-benzenetetracarboxylic acid, (pyromellitic acid), 1,2,4,5-benzenetetracarboxylic dianhydride, (pyromellitic anhydride), 3,3′,4,4′-benzophenonetetracarboxylic dianhydride, 1,4,5,8-naphthalenetetracarboxylic dianhydride, citric acid, tetrahydrofuran-2,3,4,5-tetracarboxylic acid, 1,3,5-cyclohexanetricarboxylic acid, pentaerythritol, glycerol, 2-(hydroxymethyl)-1,3-propanediol, 2,2-bis(hydroxymethyl)propionic acid, and the like and mixture therefrom. This should not be considered limiting. Essentially any polyfunctional material, which includes three or more carboxylic acid or hydroxyl functions, may find use within the invention. The polyfunctional branching agent may be included when higher resin melt viscosity is desired for specific enduses. Examples of the enduses include melt extrusion coatings, melt blown films or containers, foam and the like. The polyetherester may include 0 to 1.0 mole % of polyfunctional branching agent based on 100 mole % of the dicarboxylic acid component.

The polyetherester may be used with additives or fillers known in the art including thermal stabilizers (e.g., phenolic antioxidants) secondary thermal stabilizers (e.g., thioethers and phosphates), UV absorbers (e.g., benzophenone- and benzotriazole-derivatives), UV stabilizers (e.g., hindered amine light stabilizers or HALS), and the like. The additives may further include plasticizers, processing aides, flow enhancing additives, lubricants, pigments, flame retardants, impact modifiers, nucleating agents to increase crystallinity, antiblocking agents such as silica, base buffers, such as sodium acetate, potassium acetate, and tetramethyl ammonium hydroxide, and the like (see, e.g., U.S. Pat. No. 3,779,993, U.S. Pat. No. 4,340,519, U.S. Pat. No. 5,171,308, U.S. Pat. No. 5,171,309, and U.S. Pat. No. 5,219,646 and references cited therein). Examples of plasticizers, which may be added to improve processing, final mechanical properties, or to reduce rattle or rustle of the films, coatings and laminates of the present invention, include soybean oil, epoxidized soybean oil, corn oil, caster oil, linseed oil, epoxidized linseed oil, mineral oil, alkyl phosphate esters, Tween® 20 plasticizers, Tween® 40 plasticizers, Tween® 60 plasticizers, Tween® 80 plasticizers, Tween® 85 plasticizers, sorbitan monolaurate, sorbitan monooleate, sorbitan monopalmitate, sorbitan trioleate, sorbitan monostearate, citrate esters, such as trimethyl citrate, triethyl citrate, (Citroflex® 2 plasticizer, produced by Morflex, Inc., Greensboro, N.C.), tributyl citrate, (Citroflex® 4 plasticizer, produced by Morflex, Inc., Greensboro, N.C.), trioctyl citrate, acetyltri-n-butyl citrate, (Citroflex® A-4 plasticizer, produced by Morflex, Inc., Greensboro, N.C.), acetyltriethyl citrate, (Citroflex® A-2 plasticizer, produced by Morflex, Inc., Greensboro, N.C.), acetyltri-n-hexyl citrate, (Citroflex® A-6 plasticizer, produced by Morflex, Inc., Greensboro, N.C.), and butyryltri-n-hexyl citrate, (Citroflex® B-6 plasticizer, produced by Morflex, Inc., Greensboro, N.C.), tartarate esters, such as dimethyl tartarate, diethyl tartarate, dibutyl tartarate, and dioctyl tartarate, poly(ethylene glycol), derivatives of poly(ethylene glycol), paraffin, monoacyl carbohydrates, such as 6-O-sterylglucopyranoside, glyceryl monostearate, Myvaplex® 600 plasticizer, (concentrated glycerol monostearates), Nyvaplex® plasticizer, (concentrated glycerol monostearate which is a 90% minimum distilled monoglyceride produced from hydrogenated soybean oil and which is composed primarily of stearic acid esters), Myvacet® plasticizer, (distilled acetylated monoglycerides of modified fats), Myvacet® 507 plasticizer, (48.5 to 51.5% acetylation), Myvacet® 707 plasticizer, (66.5 to 69.5% acetylation), Myvacet® 908 plasticizer, (minimum of 96% acetylation), Myverol® plasticizer, (concentrated glyceryl monostearates), Acrawax® plasticizer, N,N-ethylene bis-stearamide, N,N-ethylene bis-oleamide, dioctyl adipate, diisobutyl adipate, diethylene glycol dibenzoate, dipropylene glycol dibenzoate, polymeric plasticizers, such as poly(1,6-hexamethylene adipate), poly(ethylene adipate), Rucoflex® plasticizer, and other compatible low molecular weight polymers and the like and mixtures thereof.

The composition or polyetherester may be filled with about 1 to about 40 or about 1 to about 30 weight %, based on total weight of final composition, inorganic, organic and clay fillers, for example, wood flour, gypsum, talc, mica, carbon black, wollastonite, montmorillonite minerals, chalk, diatomaceous earth, sand, gravel, crushed rock, bauxite, limestone, sandstone, aerogels, xerogels, microspheres, porous ceramic spheres, gypsum dihydrate, calcium aluminate, magnesium carbonate, ceramic materials, pozzolamic materials, zirconium compounds, xonotlite, (a crystalline calcium silicate gel), perlite, vermiculite, hydrated or unhydrated hydraulic cement particles, pumice, perlite, zeolites, clay fillers, silicon oxide, calcium terephthalate, aluminum oxide, titanium dioxide, iron oxides, calcium phosphate, barium sulfate, sodium carbonate, magnesium sulfate, aluminum sulfate, magnesium carbonate, barium carbonate, calcium oxide, magnesium oxide, aluminum hydroxide, calcium sulfate, barium sulfate, lithium fluoride, polymer particles, powdered metals, pulp powder, rubber, cellulose, starch, chemically modified starch, thermoplastic starch, lignin powder, wheat, chitin, chitosan, keratin, gluten, nut shell flour, wood flour, corn cob flour, calcium carbonate, calcium hydroxide, glass beads, hollow glass beads, seagel, cork, seeds, gelatins, wood flour, saw dust, agar-based materials, reinforcing agents, such as glass fiber, natural fibers, such as sisal, hemp, cotton, wool, wood, flax, abaca, sisal, ramie, bagasse, and cellulose fibers, carbon fibers, graphite fibers, silica fibers, ceramic fibers, metal fibers, stainless steel fibers, recycled paper fibers, for example, from repulping operations, and the like. A filler may improve the toughness of the composition, increase the Young's modulus, improve the dead-fold properties, improve the rigidity of the film, coating, laminate, or molded article, decrease the cost, and reduce the tendency of the film, coating, or laminate to block or self-adhere during processing or use. The fillers may also produce plastic articles which have many of the qualities of paper, such as texture and feel. See, e.g., U.S. Pat. No. 4,578,296. The additives, fillers or blend materials may be added before, at any stage during, or post, polymerization process.

Clay fillers include both natural and synthetic clays and untreated and treated clays, such as organoclays and clays which have been surface treated with silanes or stearic acid to enhance the adhesion with the polyester matrix. Examples include, kaolin, smectite clays, magnesium aluminum silicate, bentonite clays, montmorillonite clays, hectorite clays, and the like and mixtures thereof. The clays may be treated with organic materials, such as surfactants, to make them organophilic. Clays are commercial examples include those from Southern Clay Company (e.g., Gelwhite® MAS 100 clay, a white smectite clay, (magnesium aluminum silicate) and Nanocor Company (e.g., Nanomer® clay, montmorillonite minerals which have been treated with compatibilizing agents.

Some of the clay fillers may exfoliate through the process to provide nanocomposites, especially for the layered silicate clays, such as smectite clays, magnesium aluminum silicate, bentonite clays, montmorillonite clays, hectorite clays, and the like.

The filler particle size may be tailored based on the desired use of the filled polyetherester composition. For example, average diameter of the filler may be less than about 200μ or <about 40μ or <about 20μ. The filler may include particle sizes ranging up to 40 mesh (US Standard) or larger. Mixtures of filler particle sizes may be utilized. For example, mixtures of calcium carbonate fillers with average particle sizes of about 5μ and of about 0.7μ may provide better space filling of the filler within the polyester matrix. Use of two or more filler particle sizes may allow for improved particle packing, which is a process selecting two or more ranges of filler particle sizes in order that the spaces between a group of large particles are substantially occupied by a selected group of smaller filler particles. In general, the particle packing may be increased whenever any given set of particles is mixed with another set of particles having a particle size that is at least about 2 times larger or smaller than the first group of particles. The particle packing density for a two-particle system will be maximized whenever the size ratio of a given set of particles is from about 3 to 10 times the size of another set of particles. Similarly, three or more different sets of particles may be used to further increase the particle packing density. The degree of packing density that may be optimal depends on factors such as the types and concentrations of the various components within both the thermoplastic phase and the solid filler phase, the film, coating or lamination process used, and the desired mechanical, thermal and other performance properties of the final products to be manufactured. See, e.g., U.S. Pat. No. 5,527,387. Filler concentrates which incorporate a mixture of filler particle sizes based on the above particle packing techniques are commercially available by the Shulman Company under the trademark Papermatch®.

The filler or additive may be added at any stage during the polymerization or after the polymerization is completed. For example, the fillers may be added with the polyetherester monomers at the start of the polymerization process. This is preferable for, for example, the silica and titanium dioxide fillers, to provide adequate dispersion of the fillers within the polyetherester matrix. The filler may be added as the precondensate passes into the polymerization vessel or after the polyetherester exits the polymerizer. For example, the polyetherester compositions produced by the processes of the present invention may be melt fed to any intensive mixing operation, such as a static mixer or a single- or twin-screw extruder, and compounded with the filler. The polyetherester composition may be combined with the filler in a subsequent post polymerization process. Typically, such a process can involve intensive mixing of the molten polyetherester with the filler through static mixers, Brabender mixers, single screw extruders, twin screw extruders and the like. The polyetherester and the filler may be fed into two different locations of the extruder. See, e.g., U.S. Pat. No. 6,359,050. Alternatively, the filler may be blended with the polyetherester materials during the formation of the films and coatings of the present invention, as described below.

The polyetherester may be blended with other polymers including polyethylene, high density polyethylene, low density polyethylene, linear low density polyethylene, ultralow density polyethylene, polyolefins, poly(ethylene-co-glycidylmethacrylate), poly(ethylene-co-methyl (meth)acrylate-co-glycidyl acrylate), poly(ethylene-co-n-butyl acrylate-co-glycidyl acrylate), poly(ethylene-co-methyl acrylate), poly(ethylene-co-ethyl acrylate), poly(ethylene-co-butyl acrylate), poly(ethylene-co-(meth)acrylic acid), metal salts of poly(ethylene-co-(meth)acrylic acid), poly((meth)acrylates), such as poly(methyl methacrylate), poly(ethyl methacrylate), and the like, poly(ethylene-co-carbon monoxide), poly(vinyl acetate), poly(ethylene-co-vinyl acetate), poly(vinyl alcohol), poly(ethylene-co-vinyl alcohol), polypropylene, polybutylene, polyesters, poly(ethylene terephthalate), poly(1,3-propylene terephthalate), poly(1,4-butylene terephthalate), PETG, poly(ethylene-co-1,4-cyclohexanedimethanol terephthalate), polyetheresters, poly(vinyl chloride), PVDC, poly(vinylidene chloride), polystyrene, syndiotactic polystyrene, poly(4-hydroxystyrene), novalacs, poly(cresols), polyamides, nylon, nylon 6, nylon 46, nylon 66, nylon 612, polycarbonates, poly(bisphenol A carbonate), polysulfides, poly(phenylene sulfide), polyethers, poly(2,6-dimethylphenylene oxide), polysulfones, sulfonated aliphatic-aromatic copolyesters such as Biomax® (E. I. du Pont de Nemours and Company), aliphatic-aromatic copolyesters, poly(1,4-butylene adipate-co-terephthalate, (55:45, molar)), poly(1,4-butylene terephthalate-co-adipate, (50:50, molar)), aliphatic polyesters, poly(ethylene succinate), poly(1,4-butylene adipate-co-succinate), poly(1,4-butylene adipate), poly(amide esters), polycarbonates, poly(hydroxyalkanoates), poly(caprolactone), and poly(lactide), and the like and copolymers thereof and mixtures thereof.

Examples of blendable natural polymers include starch, starch derivatives, modified starch, thermoplastic starch, cationic starch, anionic starch, starch esters, such as starch acetate, starch hydroxyethyl ether, alkyl starches, dextrins, amine starches, phosphate starches, dialdehyde starches, cellulose, cellulose derivatives, modified cellulose, cellulose esters, such as cellulose acetate, cellulose diacetate, cellulose priopionate, cellulose butyrate, cellulose valerate, cellulose triacetate, cellulose tripropionate, cellulose tributyrate, and cellulose mixed esters, such as cellulose acetate propionate and cellulose acetate butyrate, cellulose ethers, such as methylhydroxyethylcellulose, hydroxymethylethylcellulose, carboxymethylcellulose, methyl cellulose, ethylcellulose, hydroxyethycellulose, and hydroxyethylpropylcellulose, polysaccharides, alginic acid, alginates, phycocolloids, agar, gum arabic, guar gum, acaia gum, carrageenan gum, furcellaran gum, ghatti gum, psyllium gum, quince gum, tamarind gum, locust bean gum, gum karaya, xantahn gum, gum tragacanth, proteins, collagen, and derivatives thereof such as gelatin and glue, casein, (the principle protein in cow milk), sunflower protein, egg protein, soybean protein, vegetable gelatins, gluten, and the like and mixtures thereof.

The polymeric material to be blended with the polymer of the present invention may be added to the polymer of the present invention at any stage during the polymerization of the polymer or after the polymerization is completed, similar to that disclosed for fillers. For example, the polyetherester and the polymeric material may be melt fed to any intensive mixing operation, such as a static mixer or a single- or twin-screw extruder and compounded with the polymeric material.

Alternatively, the blends of the polyetheresters and the polymeric material, the polyetherester may be combined with the polymeric material in a subsequent post polymerization process. Such a process involves intensive mixing of the molten polyetherester with the polymeric material through static mixers, Brabender mixers, single screw extruders, twin screw extruders and the like.

Shaped articles include film, sheets, fiber, monofilaments, nonwoven structures, melt blown containers, molded parts, foamed parts, polymeric melt extrusion coatings onto substrates, polymeric solution coatings onto substrates and the like can be made from the composition disclosed.

Molding of the polyetheresters into shaped articles may be performed by any process known in the art such as compression molding or melt forming. Melt forming can be carried out by the usual methods for thermoplastics, such as injection molding, thermoforming, extrusion, blow molding, or any combination of these methods. Compression molding may be performed through any process known within the art. Examples of compression molding processes include, for example, hand molds, semiautomatic molds, and automatic molds. The three common types of mold designs include open flash, fully positive, and semipositive. Within general compression molding operations, the polyetherester, in essentially any form, such as powder, pellet, or disc, is preferably dried and heated. The heated polyetherester is then loaded into a mold, which is typically held at a temperature between 150 to 300° C., depending on the exact polyetherester composition to be used. The mold is then partially closed and pressure is exerted. The pressure is generally between 2000 to 5000 psi, but depends on the exact compression molding process utilized, the exact polyetherester material, the part to be molded and the like. The polyetherester is melted by the action of the heat and the exerted pressure and flows into the recesses of the mold to form the shaped molded article.

Injection molding may be performed through any process known in the art. The polyetherester may be in any form such as powder, pellet or disc and is fed into the back end of an extruder, typically with an automatic feeder, such as a K-Tron® or Accurate® feeder. Other desired additives, plasticizers, blend materials, and the like, as described above, may be precompounded with the polyester of the present invention or cofed to the extruder. The polyetherester composition is then melted within the extruder and conveyed to the end of the extruder. Typically a hydraulic cylinder then pushes the screw forward to inject the molten resin composition into the mold. The mold is generally clamped together with pressure. The mold temperature is generally set at such a temperature as to allow the polyester composition to crystallize and set up. Generally it is between about room temperature and 200° C. Typically, the mold temperature is set to provide the shortest mold cycle time possible. For slow crystallizing materials, such as poly(ethylene terephthalate), typically electrical heaters or hot oil is desired. For rapidly crystallizing materials, such as poly(1,4-butylene terephthalate), steam heat may be sufficient. Once the shaped article has solidified, the mold pressure is released, the mold opened and the part is ejected from the mold cavity, typically through the help of knockout pins, ejector pins, knockout plates, stripper rings, compressed air, or combinations thereof.

Molding may provide a wide variety of shaped articles, including discs, plaques, bushings, automotive parts, such as door handles, window cranks, electrical parts, electronic mechanical parts, electrochemical sensors, positive temperature coefficient devices, temperature sensors, semiconductive shields for conductor shields, electrothermal sensors, electrical shields, high permittivity devices, housing for electronic equipment, containers and pipelines for flammable solids, powders, liquids, and gases, and the like. The molded parts can also find utility for laser marking for identification purposes. The compositions are also useful as “appearance parts”, that is parts in which the surface appearance is important. This is applicable whether the composition's surface is viewed directly, or whether it is coated with paint or another material such as a metal. Such parts include automotive body panels such as fenders, fascia, hoods, tank flaps, rocker panels, spoilers, and other interior and exterior parts; interior automotive panels, automotive trim parts, appliance parts such as handles, control panels, chassises (cases), washing machine tubs and exterior parts, interior or exterior refrigerator panels, and dishwasher front or interior panels; power tool housings such as drills and saws; electronic cabinets and housings such as personal computer housings, printer housings, peripheral housings, server housings; exterior and interior panels for vehicles such as trains, tractors, lawn mower decks, trucks, snowmobiles, aircraft, and ships; decorative interior panels for buildings; furniture such as office and/or home chairs and tables; and telephones and other telephone equipment. These parts may be painted or they may be left unpainted in the color of the composition. Automotive body panels are an especially challenging application. These materials preferably have smooth and reproducible appearance surfaces, be heat resistant so they can pass through without significant distortion automotive E-coat and paint ovens where temperatures may reach as high as about 200° C. for up to 30 minutes for each step, be tough enough to resist denting or other mechanical damage from minor impacts.

The carbon black-containing polyetheresters may allow for the parts to dissipate electrical charges formed on the part as it is being electrostatically painted, providing an even coating of paint over the entire part. Electrostatic painting of substrates can reduce paint waste and emissions as compared to non-electrostatic painting processes allowing for relatively large parts to be consistently painted without color differences over the surface of the part. The polyetherester compositions disclosed herein can be electrostatically paintable while maintaining the desirable physical properties due to the low carbon loadings incorporation.

A film comprising the polyetherester has a variety of uses such as in packaging, especially of foodstuffs, adhesives tapes, insulators, capacitors, photographic development, x-ray development and as laminates, for example. Of particular note, the films can be used in EMI shielding, as protective film for microwave antennas, as a radome, as a sunshield, packaging for electrically sensitive products, such as electronics, conductive film, charge-transporting components for electrographic imaging equipment, and the like and can be used for laser marking for identification purposes. A film with higher melting point, glass transition temperature, and crystallinity level is desirable to provide better heat resistance and more stable electrical characteristics. It is also desired that the films have good barrier properties such as moisture barrier, oxygen barrier and carbon dioxide barrier, good grease resistance, good tensile strength and a high elongation at break.

The polyetheresters may be formed into a film for use in any one of the many different applications, such as packaging, labels, EMI shielding, or the like. While not limiting, the monomer composition of the polyetherester polymer is preferably chosen to result in a partially crystalline polymer desirable for the formation of film, wherein the crystallinity provides strength and elasticity. As first produced, the polyetherester is generally semi-crystalline in structure. The crystallinity increases on reheating and/or stretching of the polymer, as occurs in the production of film.

Film is made by any process known in the art such as disclosed in U.S. Pat. No. 4,372,311 (thin films may be formed through dipcoating), U.S. Pat. No. 4,427,614 (compression molding), U.S. Pat. No. 4,880,592 (melt extrusion), U.S. Pat. No. 5,525,281 (melt blowing), or other processes such as solution casting. Because the processed are well known, the description of which is omitted for the interest of brevity. A film is ≦0.25 mm (10 mils) thick, between about 0.025 mm and 0.15 mm (1 mil and 6 mils), or about 0.50 mm (20 mils).

Extrusion can form “endless” products, such as films and sheets, which emerge as a continuous length. In extrusion, the polymeric material, whether provided as a molten polymer or as plastic pellets or granules, is fluidized and homogenized. Additives, as described above, such as thermal or UV stabilizers, plasticizers, fillers and/or blendable polymeric materials, may be added, if desired. Because extrusion is well known to one skilled in the art, the description of which is omitted for the interest of brevity.

For manufacturing large quantities of film, a sheeting calender may be employed. The rough film is fed into the gap of the calender, a machine comprising a number of heatable parallel cylindrical rollers which rotate in opposite directions and spread out the polymer and stretch it to the required thickness. The last roller smooths the film thus produced. If the film is required to have a textured surface, the final roller is provided with an appropriate embossing pattern. Alternatively, the film may be reheated and then passed through an embossing calender. The calender is followed by one or more cooling drums. Finally, the finished film is reeled up.

Extruded films may be used as the starting material for other products. The film may be cut into small segments for use as feed material for other processing methods, such as injection molding. As a further example, the film may be laminated onto a substrate as described below. As yet a further example, the films may be metallized, as taught within the art. The film tubes available from blown film operations may be converted to bags through, for example, heat sealing processes.

Multilayer films may also be produced, such as bilayer, trilayer, and multilayer film structures such that specific properties can be tailored into the film to solve critical use needs while allowing the more costly ingredients to be relegated to the outer layers where they provide the greater needs. Multilayer film structures may be produced by coextrusion, blown film, dipcoating, solution coating, blade, puddle, air-knife, printing, Dahigren, gravure, powder coating, spraying, or other processes as well known to one skilled in the art. See, e.g., U.S. Pat. No. 4,842,741, U.S. Pat. No. 6,309,736, U.S. Pat. No. 3,748,962, U.S. Pat. No. 4,522,203, U.S. Pat. No. 4,734,324, U.S. Pat. No. 5,261,899 and U.S. Pat. No. 6,309,736.

A film may be subject to orientation, uniaxially or biaxially, as well known to one skilled in the art.

Orientation may be enhanced within blown film operations by adjusting the blow-up ratio (BUR), which is defined as the ratio of the diameter of the film bubble to the die diameter. For a balanced film, a BUR of about 3:1 may be appropriate. If it is desired to have a “splitty” film which easily tears in one direction, then a BUR of 1:1 to about 1.5:1 is preferred.

Shrinkage can be controlled by holding the film in a stretched position and heating for a few seconds before quenching. This heat stabilizes the oriented film, which then may be forced to shrink only at temperatures above the heat stabilization temperature. Further, the film may also be subjected to rolling, calendering, coating, embossing, printing, or any other typical finishing operations known within the art.

A film, especially a filled film, may be formed microporous, if desired as disclosed in U.S. Pat. No. 4,626,252, U.S. Pat. No. 5,073,316, and U.S. Pat. No. 6,359,050. To enhance the printability, ink receptivity of the surface, adhesion or other desirable characteristics, a film may be treated by known, conventional post forming operations, such as corona discharge, chemical treatments, flame treatment, and the like. A film may be further processed to produce additional desirable articles, such as containers. For example, the films may be thermoformed as disclosed in U.S. Pat. No. 3,303,628, U.S. Pat. No. 3,674,626, and U.S. Pat. No. 5,011,735.

The carbon black-containing polyetherester can be coated or laminated onto a substrate. Shaped articles may be produced therefrom. Coatings may be produced by coating a substrate with polymer solutions, dispersions, latexes, and emulsions of the copolyesters of the present invention through rolling, spreading, spraying, brushing, or pouring processes, followed by drying, by coextruding the polyetherester with other materials, powder coating onto a preformed substrate, or by melt/extrusion coating a preformed substrate with the polyetheresters of the present invention. The coated substrates may have a variety of uses, such as in packaging, especially static charge dissipative packaging for, for example, sensitive electronic parts, semiconductive cable jacket, EMI shielding, and as disposable products. Again, a higher melting point, glass transition temperature, and crystallinity level are desirable to provide better heat resistance and the coatings can provide good barrier properties for moisture, grease, oxygen, and carbon dioxide, and have good tensile strength and a high elongation at break.

The coating may be made from the polymer by any process known in the art such as dipcoating (see, e.g., U.S. Pat. No. 4,372,311 and U.S. Pat. No. 4,503,098), extrusion onto substrates (see, e.g., U.S. Pat. No. 5,294,483, U.S. Pat. No. 5,475,080, U.S. Pat. No. 5,611,859, U.S. Pat. No. 5,795,320, U.S. Pat. No. 6,183,814, and U.S. Pat. No. 6,197,380), spraying (see, e.g., U.S. Pat. No. 4,117,971, U.S. Pat. No. 4,168,676, U.S. Pat. No. 4,180,844, U.S. Pat. No. 4,211,339, U.S. Pat. No. 4,283,189, U.S. Pat. No. 5,078,313, U.S. Pat. No. 5,281,446, and U.S. Pat. No. 5,456,754), blade, puddle, air-knife, printing, Dahlgren, gravure, powder coating, spraying, or other art processes. See also, U.S. Pat. No. 3,924,013, U.S. Pat. No. 4,147,836, U.S. Pat. No. 4,391,833, U.S. Pat. No. 4,595,611, U.S. Pat. No. 4,957,578, U.S. Pat. No. 5,942,295, U.S. Pat. No. 3,924,013, U.S. Pat. No. 4,836,400, U.S. Pat. No. 5,294,483.

The coatings may be of any thickness including ≦2.5 mm (100 mils) or ≦0.25 mm (10 mils) thick, or between about 0.025 mm and 0.15 mm (1 mil and 6 mils), or up to a thickness of about 0.50 mm (20 mils) or greater. Because coating is well known to one skilled in the art, the description of which is omitted for the interest of brevity.

Substrates of the coating can include metal, glass, ceramic tile, brick, concrete, wood, masonry, fiber, leather, film, plastics, polystyrene foam, polymeric foams, organic foams, inorganic foams, organic-inorganic foams, stone, foil, metal foils, paperboard, cardboard, fiberboard, cellulose, webs such as organic polymers, metal foils, bleached and unbleached papers and board, non-woven fabrics, and composites of such materials.

To enhance the coating process, the substrates may be treated by known, conventional post forming operations, such as corona discharge, chemical treatments, such as primers, flame treatments, adhesives, and the like. The substrate layer may be primed with, for example, an aqueous solution of polyethyleneimine, (Adcote® 313), or a styrene-acrylic latex, or may be flame treated, as taught within U.S. Pat. No. 4,957,578 and U.S. Pat. No. 5,868,309.

The substrate may be coated with an adhesive such as glue, gelatine, caesin, starch, cellulose esters, aliphatic polyesters, poly(alkanoates), aliphatic-aromatic polyesters, sulfonated aliphatic-aromatic polyesters, polyamide esters, rosin/polycaprolactone triblock copolymers, rosin/poly(ethylene adipate) triblock copolymers, rosin/poly(ethylene succinate) triblock copolymers, poly(vinyl acetates), poly(ethylene-co-vinyl acetate), poly(ethylene-co-ethyl acrylate), poly(ethylene-co-methyl acrylate), poly(ethylene-co-propylene), poly(ethylene-co-1-butene), poly(ethylene-co-1-pentene), poly(styrene), acrylics, Rhoplex® N-1031 (an acrylic latex from the Rohm & Haas Company), and the like and mixtures thereof. The adhesives may be applied through melt processes or through solution, emulsion, dispersion, and the like, coating processes.

A substrate may be formed into certain articles prior to coating or may be formed into certain articles after they are coated.

A film comprising the polyetherester may be laminated onto a wide variety of substrates through thermoforming, vacuum thermoforming, vacuum lamination, pressure lamination, mechanical lamination, skin packaging, or adhesion lamination.

For example, processes for producing coated or laminated paper and paperboard substrates for use as containers and cartons is well known within the art (see, e.g., U.S. Pat. No. 3,863,832, U.S. Pat. No. 3,866,816, U.S. Pat. No. 4,337,116, U.S. Pat. No. 4,456,164, U.S. Pat. No. 4,698,246, U.S. Pat. No. 4,701,360, U.S. Pat. No. 4,789,575, U.S. Pat. No. 4,806,399, U.S. Pat. No. 4,888,222, U.S. Pat. No. 5,002,833, U.S. Pat. No. 3,924,013, U.S. Pat. No. 4,130,234, U.S. Pat. No. 6,045,900 and U.S. Pat. No. 6,309,736). Depending on the intended use of the polyester laminated substrate, the substrate may be laminated on one side or on both sides.

The polyetherester composition may further find use in the form of sheets. Polymeric sheets have a variety of uses, such as in signage, glazings, thermoforming articles, displays and display substrates, for example. The carbon black component within the polyetherester allows for the sheets to dissipate electrical charges formed on the part as it is being electrostatically painted, providing an even coating of paint over the entire sheet. This allows for relatively large sheets to be consistently painted without color differences over the surface of the part. A polyetherester composition may be electrostatically paintable while maintaining the majority of their desirable physical properties due to the low carbon loadings incorporated therein. Sheets produced therefrom can be used for laser marking for identification purposes.

The sheet may be formed by any methods known in the art such as extrusion, solution casting, injection molding, or directly from a polymerization melt. Because such methods are well known to one skilled in the art, the description of which is omitted for the interest of brevity. The sheet can be used for forming signs, glazings (such as in bus stop shelters, sky lights or recreational vehicles), displays, automobile lights and in thermoforming articles, covers, skylights, shaped greenhouse glazings, food trays, and the like. Sheets can also be oriented as film disclosed above.

Sheets and sheet-like articles, such as discs, may be formed by injection molding by any method known in the art.

The difference between a sheet and a film is the thickness, but there is no set industry standard as to when a film becomes a sheet. A sheet is >about 0.25 mm (10 mils) thick, between about 0.25 mm and 25 mm, about 2 mm to about 15 mm, about 3 mm to about 10 mm thick. Sheets >25 mm, and thinner than 0.25 mm may be formed.

The carbon black-containing polyetherester may be used in the form of fibers, which are desirable for use in textiles, particularly in combination with natural fibers such as cotton and wool. Clothing, rugs, and other items may be fashioned from these fibers. Further, polyester fibers are desirable for use in industrial applications due to their elasticity and strength. In particular, they are used to make articles such as tire cords and ropes.

Fibers (“fibers” include continuous monofilaments, non-twisted or entangled multifilament yarns, staple yarns, spun yarns, melt blown fibers, non-woven materials, and melt blown non-woven materials) containing the carbon black-containing polyetherester cover the entire range of electrical properties; antistatic, static dissipating or moderately conductive, and conductive. The fiber may take many forms, including homogeneous and bi-component. The polyetherester may serve as a conductive core covered by a dielectric sheath material. Antistatic fibers produced from the polyetherester may provide antistatic protection in all types of textile end uses, including knitted, tufted, woven, and nonwoven textiles, hairbrush, belting materials for, for example, paper production clothing, poultry belts, package conveyance belts, and the like. Fibers containing the carbon black-containing polyetherester may provide antistatic protection to carpet structures.

The fiber may be used with another synthetic or natural polymer to form heterogenous fiber, thereby providing a fiber with improved properties or be stabilized with an effective amount (such as 0.1 to 10.0 weight % based on polyetherester) of any known hydrolysis stabilization additive. The hydrolysis stabilization additive chemically reacts with the carboxylic acid endgroups and is preferably carbodiimides. The hydrolysis stabilization additive may include diazomethane, carbodiimides, epoxides, cyclic carbonates, oxazolines, aziridines, keteneimines, isocyanates, alkoxy end-capped polyalkylene glycols, and the like. The incorporation of such additive is well known to one skilled in the art.

The carbon black-containing polyetherester may be formed into monofilaments by any known method within the art such as disclosed in U.S. Pat. No. 3,051,212, U.S. Pat. No. 3,999,910, U.S. Pat. No. 4,024,698, U.S. Pat. No. 4,030,651, U.S. Pat. No. 4,072,457, and U.S. Pat. No. 4,072,663.

At low ppm levels (5-25 ppm by weight), carbon blacks may serve as reheat catalysts for preforms within the melt blown molding processes to produce containers, such as soda bottles. At the intermediate levels (0.05-0.5 weight %) carbon blacks may serve as potent nucleation agents to enhance the rate of crystallization of certain polyetherester compositions.

The carbon black component may be added to the process for the present invention as a dry, raw black, as a slurry in a suitable fluid, preferably the above mentioned glycol component, or as a dispersion in a suitable fluid, preferably the above mentioned glycol component. The carbon black may be added to the polyester polymerization process as a deagglomerated dispersion in, preferably, the glycol utilized within the certain polyetherester composition to be produced, as described above.

The carbon black may be added to the process as a dry, raw black, as a slurry in a suitable fluid such as the glycol or poly(alkylene ether)glycol disclosed above, or as a dispersion in a suitable fluid such as the glycol or poly(alkylene ether)glycol.

To produce a carbon black dispersion, the preferred glycol-carbon black slurry can be subject to intensive mixing and grinding using mechanical dispersing equipment include ball mills, Epenbauch mixers, Kady high shear mill, sandmill, (for example, a 3P Redhead sandmill), and attrition grinding apparatus.

A carbon black dispersion can be produced, for example, through a ball milling process by adding the carbon black to a glycol, such as ethylene glycol, with ceramic or stainless steel balls, followed by rotating the ball mill for the amount of time necessary to produce the desired dispersion. Typically, this time is from 0.5 to 50 hours. The dispersion may further be centrifuged to remove any large particles of the carbon black or the grinding media, if desired.

The amount of carbon black dispersed within the glycol depends on the exact structure and nature of the carbon black to be dispersed and can be the amount that is dispersed homogeneously in the glycol.

A dispersing agent, to enhance the wetting of the carbon particles by the glycol and to help maintain the formation of stable dispersions, may be incorporated into the carbon black component, if desired. Examples of suitable dispersing agents include: polyvinylpyrrolidone, epoxidized polybutadiene, a sodium salt of a sulfonated naphthalene, and fatty acids. The level of the dispersing agent can be in the range of about 0.1 to 8 weight % of the total dispersion (carbon black, dispersing agent, and glycol).

The carbon black component may be added at any stage of the polyetherester polymerization prior to the polyetherester achieving an IV of above about 0.20 dL/g or be added at the monomer stage, such as with the dicarboxylic acid, with the poly(alkylene ether)glycol, or with the glycol, or to the initial (trans)esterification product, (precondenstates), ranging from the bis(glycolate) to polyetherester oligomers with degrees of polymerization (DP) of about 10 or less, or be added with the glycol or to the initial (trans)esterification product.

The polyetherester composition may be prepared by well known conventional polycondensation techniques. For example, acid chloride of a dicarboxylic acid may be combined with a glycol and a poly(alkylene ether)glycol a in a solvent, such as toluene, in the presence of a base, such as pyridine, which neutralizes the hydrochloric acid as it is produced. Such procedures are known. See, e.g., R. Storbeck, et. al., in J. Appl. Polymer Science, Vol. 59, pp. 1199-1202 (1996).

When the polymer is made using acid chlorides, the ratio of the monomer units in the product polymer is about the same as the ratio of reacting monomers. Therefore, the ratio of monomers charged to the reactor is about the same as the desired ratio in the product. A stoichiometric equivalent of the sum of the glycol and poly(alkylene ether)glycol and the dicarboxylic acid generally may be used to obtain a high molecular weight polymer.

The polyetherester may be produced through a melt polymerization method where the dicarboxylic acid (either as acids, esters, bisglycolates or mixtures thereof), glycol, the poly(alkylene ether)glycol, the carbon black, and the optional polyfunctional branching agent are combined in the presence of a catalyst to a high enough temperature that the monomers combine to form esters and diesters, then oligomers, and finally polymers. The polymeric product at the end of the polymerization process is a molten product and the glycol component distills from the reactor as the polymerization proceeds. Such procedures are generally known within the teachings of the art.

The amount of glycol component, poly(alkylene ether)glycol component, dicarboxylic acid component, carbon black component, and optional branching agent are desirably chosen so that the final product contains the desired amounts of the various monomer units as disclosed above. The exact amount of monomers to be charged to a particular reactor is readily determined by a skilled practitioner such as the ranges below. Excesses of the dicarboxylic acid and the glycol are often desirably charged, and the excess dicarboxylic acid and glycol is desirably removed by distillation or other means of evaporation as the polymerization reaction proceeds. Preferred glycol components, such as ethylene glycol, 1,3-propanediol, and 1,4-butanediol, are desirably charged at a level 10 to 100% greater than the desired incorporation level in the final polymer. For example, ethylene glycol is charged at a level of 40 to 100%>the desired incorporation level in the final polymer and 1,3-propanediol and 1,4-butanediol are charged at a level 20 to 70%>the desired incorporation level in the final polymer. Other glycol components are desirably charged at a level 0 to 100%>the desired incorporation level in the final product, depending on the exact volatility of the other glycol component.

The ranges given for the monomers are wide because of the variation in the monomer loss during polymerization, depending on the efficiency of distillation columns and other kinds of recovery and recycle systems and the like, and are only an approximation. Exact amounts of monomers that are charged to a specific reactor to achieve a specific composition are readily determined by a skilled practitioner.

The polymerization can include heating a mixture comprising the monomers and carbon black gradually with mixing, optionally a catalyst or catalyst mixture, to a temperature in the range of about 200° C. to about 330° C., desirably 220° C. to 295° C. The exact conditions and the catalysts depend on whether the dicarboxylic acid component is polymerized as true acids, as dimethyl esters, or as bisglycolates. The catalyst may be included initially with the reactants, and/or may be added one or more times to the mixture as it is heated. The catalyst used may be modified as the reaction proceeds. The heating and stirring are continued for a sufficient time and to a sufficient temperature, generally with removal by distillation of excess reactants, to yield a molten polymer having a high enough molecular weight to be suitable for making fabricated products.

Catalyst may include all polyester polycondensation catalyst such as a salt of Li, Ca, Mg, Mn, Zn, Pb, Sb, Sn, Ge, and Ti, such as acetate salts and oxides, including glycol adducts, and Ti alkoxides. These are generally known in the art, and the description of which is omitted for the interest of brevity.

The desired physical properties include an Inherent Viscosity (IV), which is an indicator of molecular weight, of at least ≧0.25 or ≧0.35 or ≧0.5 dL/g, as measured on a 0.5% (weight/volume) solution of the polyester in a 50:50 (weight) solution of trifluoroacetic acid:dichloromethane solvent system at room temperature. Higher inherent viscosities may be desirable for other applications such as films, bottles, sheet, molding resin and the like. The polymerization conditions may be adjusted to obtain a desired IV up to at least about 0.5 and desirably >0.65 dL/g. Further processing of the polyetherester may achieve inherent viscosities of 0.7, 0.8, 0.9, 1.0, 1.5, 2.0 dL/g and even higher.

The molecular weight is normally not measured directly. Instead, the IV of the polymer in solution or the melt viscosity is used as an indicator of molecular weight. The IVs are an indicator of molecular weight for comparisons of samples within a polymer family, such as poly(ethylene terephthalate), poly(butylene terephthalate), etc., and are used as the indicator of molecular weight herein. Solid state polymerization may be used to achieve even higher IVs (molecular weights).

The product made by melt polymerization, after extruding, cooling and pelletizing, may be essentially noncrystalline. Noncrystalline materials can be made semicrystalline by heating it to a temperature above the glass transition temperature for an extended period of time. This induces crystallization so that the product can then be heated to a higher temperature to raise the molecular weight.

The polymer may be crystallized prior to solid state polymerization by treatment with a relatively poor solvent for polyetheresters which induces crystallization. Such solvents reduce the glass transition temperature (Tg) allowing for crystallization. See, e.g., U.S. Pat. No. 5,164,478 and U.S. Pat. No. 3,684,766.

The semicrystalline polymer can be subject to solid state polymerization by placing the pelletized or pulverized polymer into a stream of an inert gas, usually nitrogen, or under a vacuum of 1 Torr, at an elevated temperature, often below the melting temperature of the polymer for an extended period of time.

The carbon black component may be added to the process for the present invention as a dry, raw black, as a slurry in a suitable fluid, preferably the above mentioned glycol component, or as a dispersion in a suitable fluid, preferably, the above mentioned glycol component.

The polyetherester compositions produced by the process of the present invention may incorporate additives, plasticizers, fillers, or other blend materials as disclosed above. The polyetherester produced may be formed into shaped articles, such as molded parts, films, sheets, fiber, monofilament, nonwoven structures, melt blown containers, coatings, laminates, and the like, as disclosed above.

### EXAMPLES AND COMPARATIVE EXAMPLES

Test Methods Differential

Scanning Calorimetry (DSC), was performed on a TA Instruments Model Number 2920 machine. Samples are heated under a nitrogen atmosphere at a rate of 20° C./minute to 300° C., programmed cooled back to room temperature at a rate of 20° C./minute and then reheated to 300° C. at a rate of 20° C./minute. The observed sample glass transition temperature (Tg) and crystalline melting temperature (Tm), noted below were from the second heat.

IV defined in “Preparative Methods of Polymer Chemistry”, W. R. Sorenson and T. W. Campbell, 1961, p. 35 was determined at a concentration of 0.5 g./100 ml of a 50:50 weight % trifluoroacetic acid:dichloromethane acid solvent system at room temperature by a Goodyear R-103B method.

Laboratory Relative Viscosity (LRV) was the ratio of the viscosity of a solution of 0.6 g of the polyester sample dissolved in 10 ml of hexafluoroisopropanol (HFIP) containing 80 ppm sulfuric acid to the viscosity of the sulfuric acid-containing hexafluoroisopropanol itself, both measured at 25° C. in a capillary viscometer. The LRV may be numerically related to IV. Where this relationship was utilized, the term “calculated IV” was noted.

Surface resistivity was measured on melt pressed films of the compositions noted with a T Rex Model Number 152 CE Resistance Meter, (T Rek, Inc.), at a 10 volt test voltage. This meter tested samples only down to 10³ Ohms per square. Any measurements measured at 10³ Ohms per square could have surface resistivities less than 10³ Ohms per square.

### Example 1

To a 250 ml glass flask was added dimethyl terephthalate (65.87 g), 1,4-butanediol (39.74 g), poly(tetramethylene ether)glycol (74.63 g, average molecular weight of 1400), Ketjenblack® EC 600 JD (0.75 g), and titanium(IV) isopropoxide (0.1174 g). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.2 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.3 hours while under a slow nitrogen purge. After achieving 200° C., the resulting reaction mixture was stirred at 200° C. for 0.6 hours while under a slow nitrogen purge. The reaction mixture was then stirred and heated to 225° C. over 0.4 hours while under a slow nitrogen purge. After achieving 225° C., the resulting reaction mixture was stirred at 225° C. for 0.6 hours while under a slow nitrogen purge. The reaction mixture was heated to 255° C. over 0.4 hours with stirring under a slow nitrogen purge. The resulting reaction mixture was stirred at 255° C. under a slight nitrogen purge for 0.6 hours. 17.3 g of a colorless distillate was collected over this heating cycle. The reaction mixture was then staged to full vacuum with stirring at 255° C. The resulting reaction mixture was stirred for 2.2 hours under full vacuum, (pressure less than 100 mtorr). The vacuum was then released with nitrogen and the reaction mass allowed to cool to room temperature. An additional 7.1 g of distillate was recovered and 127.0 g of a solid product was recovered.

The sample was measured for LRV as described above and was found to have an LRV of 44.33 and was calculated to have an IV of 1.05 dL/g.

The sample underwent differential DSC analysis. A recrystallization temperature was found on the programmed cool after the first heat cycle with an onset at 174.3° C. and a peak at 168.2° C. (27.2 J/g). A crystalline Tm was observed at 198.4° C., (24.8 J/g).

The surface resistivity was 1.54×10¹² Ohms per square.

### Example 2

To a 250 milliliter glass flask was added dimethyl terephthalate (65.54 g), 1,4-butanediol (39.54 g), poly(tetramethylene ether)glycol (74.25 g, average molecular weight of 1400), Ketjenblack® EC 600 JD (1.50 g), and titanium(IV) isopropoxide (0.1220 g). The reaction mixture was stirred and heated to 180° C. under a slow nitrogen purge. After achieving 180° C., the resulting reaction mixture was stirred at 180° C. for 1.0 hour while under a slow nitrogen purge. The reaction mixture was then stirred and heated to 200° C. over 0.3 hours while under a slow nitrogen purge. After achieving 200° C., the resulting reaction mixture was stirred at 200° C. for 0.6 hours while under a slow nitrogen purge. The reaction mixture was then stirred and heated to 225° C. over 0.2 hours while under a slow nitrogen purge. After achieving 225° C., the resulting reaction mixture was stirred at 225° C. for 0.6 hours while under a slow nitrogen purge. The reaction mixture was heated to 255° C. over 0.8 hours with stirring under a slow nitrogen purge. The resulting reaction mixture was stirred at 255° C. under a slight nitrogen purge for 0.8 hours. 12.8 g of a colorless distillate was collected over this heating cycle. The reaction mixture was then staged to full vacuum with stirring at 255° C. The resulting reaction mixture was stirred for 1.3 hours under full vacuum, (pressure less than 100 mtorr). The vacuum was then released with nitrogen and the reaction mass allowed to cool to room temperature. An additional 8.1 g of distillate was recovered and 97.0 g of a solid product was recovered.

The sample had an LRV of 20.16 and an IV of 0.61 dL/g.

DSC analysis showed that a recrystallization temperature was found on the programmed cool after the first heat cycle with an onset at 173.6° C. and a peak at 168.0° C., (23.8 J/g). A crystalline Tm was observed at 197.7° C., (17.9 J/g).

### Example 3

Bis(2-hydroxyethyl)terephthalate (165.45 g), poly(ethylene glycol) (22.05 g, average molecular weight=1500), a ball milled dispersion of 1.0 weight % Ketjenblack® EC 600 JD in ethylene glycol (227.3 g, provided as Aquablak® 6025 from Solution Dispersions, Inc.), manganese(II) acetate tetrahydrate (0.0669 g), and antimony(III) trioxide (0.0539 g) were added to a 500 milliliter glass flask. The mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.6 hours while under a slow nitrogen purge. The reaction mixture was heated to 295° C. over 1.1 hours with stirring under a slow nitrogen purge. The resulting reaction mixture was stirred at 295° C. under a slight nitrogen purge for 0.7 hours. 244.4 g of a colorless distillate was collected over this heating cycle. The reaction mixture was then staged to full vacuum with stirring at 295° C. The resulting reaction mixture was stirred for 3.1 hours under full vacuum, (pressure less than 100 mtorr). The vacuum was then released with nitrogen and the reaction mass allowed to cool to room temperature. An additional 18.9 g of distillate was recovered and 136.7 g of a solid product was recovered.

The sample had an LRV of 17.63 and an IV of 0.56 dL/g.

DSC analysis showed a recrystallization temperature was found on the programmed cool after the first heat cycle with an onset at 196.3° C. and a peak at 191.0° C., (32.9 J/g). A crystalline Tm was observed at 232.5° C., (32.5 J/g).

The surface resistivity was 3.93×10⁵ Ohms per square.

### Example 4

To a 250 milliliter glass flask was added dimethyl terephthalate, (65.21 g), 1,4-butanediol, (39.34 g), poly(tetramethylene ether)glycol, (73.88 g, average molecular weight of 1400), Ketjenblack® EC 600 JD, (2.25 g), and titanium(IV) isopropoxide, (0.1188 g). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 190° C. over 0.3 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.3 hours while under a slow nitrogen purge. After achieving 200° C., the resulting reaction mixture was stirred at 200° C. for 0.5 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.5 hours while under a slow nitrogen purge. The reaction mixture was heated to 255° C. over 0.3 hours with stirring under a slow nitrogen purge. The resulting reaction mixture was stirred at 255° C. under a slight nitrogen purge for 0.6 hours. 17.3 g of a colorless distillate was collected over this heating cycle. The reaction mixture was then staged to full vacuum with stirring at 255° C. The resulting reaction mixture was stirred for 2.1 hours under full vacuum, (pressure less than 100 mtorr). The vacuum was then released with nitrogen and the reaction mass allowed to cool to room temperature. An additional 7.3 g of distillate was recovered and 134.4 g of a solid product was recovered.

The sample had an LRV of 23.21 and an IV of 0.67 dL/g.

DSC analysis showed a recrystallization temperature was found on the programmed cool after the first heat cycle with an onset at 173.7° C. and a peak at 168.0° C., (28.4 J/g). A crystalline Tm was observed at 197.5° C., (30.8 J/g).

### Example 5

To a 250 milliliter glass flask was added dimethyl terephthalate, (105.07 g), dimethyl isophthalate, (11.77 g), 1,4-butanediol, (73.00 g), poly(tetramethylene ether)glycol, (14.93 g, average molecular weight of 1000), Ketjenblack® EC 600 JD, (3.00 g), and titanium(IV) isopropoxide, (0.1580 g). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.2 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.2 hours while under a slow nitrogen purge. After achieving 200° C., the resulting reaction mixture was stirred at 200° C. for 1.0 hour while under a slow nitrogen purge. The reaction mixture was then stirred and heated to 225° C. over 0.3 hours while under a slow nitrogen purge. After achieving 225° C., the resulting reaction mixture was stirred at 225° C. for 0.7 hours while under a slow nitrogen purge. The reaction mixture was heated to 255° C. over 0.4 hours with stirring under a slow nitrogen purge. The resulting reaction mixture was stirred at 255° C. under a slight nitrogen purge for 0.6 hours. 26.5 g of a colorless distillate was collected over this heating cycle. The reaction mixture was then staged to full vacuum with stirring at 255° C. The resulting reaction mixture was stirred for 1.2 hours under full vacuum, (pressure less than 100 mtorr). The vacuum was then released with nitrogen and the reaction mass allowed to cool to room temperature. An additional 8.8 g of distillate was recovered and 127.6 g of a solid product was recovered.

The sample had an LRV of 24.40 an IV of 0.69 dL/g.

DSC analysis. A recrystallization temperature was found on the programmed cool after the first heat cycle with an onset at 176.6° C. and a peak at 173.1° C., (40.4 J/g). Tm was observed at 205.9° C., (35.8 J/g).

The surface resistivity was 1.15×10⁴ Ohms per square.

### Example 6

To a 250 milliliter glass flask, bis(2-hydroxyethyl)terephthalate, (170.82 g), poly(ethylene glycol), (18.00 g, average molecular weight of 1400), Ketjenblack® EC 600 JD, (3.00 g), manganese(II) acetate tetrahydrate, (0.0676 g), and antimony(III) trioxide, (0.0540 g) were added. The reaction mixture was stirred and heated to 180° C. under a slow nitrogen purge. After achieving 180° C., the resulting reaction mixture was stirred at 180° C. for 0.4 hours while under a slow nitrogen purge. The reaction mixture was then stirred and heated to 225° C. over 0.4 hours while under a slow nitrogen purge. After achieving 225° C., the resulting reaction mixture was stirred at 225° C. for 0.6 hours while under a slow nitrogen purge. The reaction mixture was heated to 295° C. over 0.6 hours with stirring under a slow nitrogen purge. The resulting reaction mixture was stirred at 295° C. under a slight nitrogen purge for 1.1 hours. 22.6 g of a colorless distillate was collected over this heating cycle. The reaction mixture was then staged to full vacuum with stirring at 295° C. The resulting reaction mixture was stirred for 3.1 hours under full vacuum, (pressure less than 100 mtorr). The vacuum was then released with nitrogen and the reaction mass allowed to cool to room temperature. An additional 17.4 g of distillate was recovered and 132.3 g of a solid product was recovered.

The sample had an LRV of 13.88 and an IV of 0.50 dL/g.

DSC analysis. A recrystallization temperature was found on the programmed cool after the first heat cycle with an onset at 210.3° C. and a peak at 205.5° C., (36.5 J/g). Tm was observed at 247.0° C., (37.6 J/g).

The surface resistivity was 6.17×10³ Ohms per square.

### Example 7

To a 500 milliliter glass flask, bis(2-hydroxyethyl)terephthalate, (170.82 g), poly(ethylene glycol), (18.00 g, average molecular weight=1500), a ball milled dispersion of 2.9 weight % Ketjenblack® EC 600 JD and 0.7 weight % polyvinyl pyrrolidone in ethylene glycol, (103.45 g, provided as Aquablak® 6026 from Solution Dispersions, Inc.), manganese(II) acetate tetrahydrate, (0.0669 g), and antimony(III) trioxide, (0.0539 g) were added. The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.7 hours while under a slow nitrogen purge. After achieving 225° C., the resulting reaction mixture was stirred at 225° C. for 0.6 hours while under a slow nitrogen purge. The reaction mixture was heated to 295° C. over 0.9 hours with stirring under a slow nitrogen purge. The resulting reaction mixture was stirred at 295° C. under a slight nitrogen purge for 0.7 hours. 127.6 g of a colorless distillate was collected over this heating cycle. The reaction mixture was then staged to full vacuum with stirring at 295° C. The resulting reaction mixture was stirred for 2.9 hours under full vacuum, (pressure less than 100 mtorr). The vacuum was then released with nitrogen and the reaction mass allowed to cool to room temperature. An additional 16.3 g of distillate was recovered and 133.8 g of a solid product was recovered.

The sample had an LRV of 13.12 and an IV of 0.48 dL/g.

DSC analysis. A recrystallization temperature was found on the programmed cool after the first heat cycle with an onset at 204.5° C. and a peak at 200.2° C., (39.2 J/g). A crystalline Tm was observed at 240.8° C., (41.8 J/g).

The surface resistivity was 3.94×10⁴ Ohms per square.

### Example 8

To a 250 milliliter glass flask, bis(2-hydroxyethyl)terephthalate, (165.45 g), poly(ethylene glycol), (22.05 g, average molecular weight of 1500), Ketjenblack® EC 600 JD, (3.00 g), manganese(II) acetate tetrahydrate, (0.0669 g), and antimony(III) trioxide, (0.0539 g) were added. The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.5 hours while under a slow nitrogen purge. The reaction mixture was heated to 295° C. over 0.9 hours with stirring under a slow nitrogen purge. The resulting reaction mixture was stirred at 295° C. under a slight nitrogen purge for 0.8 hours. 27.3 g of a colorless distillate was collected over this heating cycle. The reaction mixture was then staged to full vacuum with stirring at 295° C. The resulting reaction mixture was stirred for 3.4 hours under full vacuum, (pressure less than 100 mtorr). The vacuum was then released with nitrogen and the reaction mass allowed to cool to room temperature. An additional 15.8 g of distillate was recovered and 137.5 g of a solid product was recovered.

The sample had an LRV of 10.70 and an IV of 0.44 dL/g.

DSC analysis. A recrystallization temperature was found on the programmed cool after the first heat cycle with an onset at 205.9° C. and a peak at 201° C., (36.5 J/g). A crystalline Tm was observed at 247.4° C., (38.5 J/g).

### Example 9

To a 250 milliliter glass flask was added dimethyl terephthalate, (64.88 g), 1,4-butanediol, (39.14 g), poly(tetramethylene ether)glycol, (73.50 g, average molecular weight of 1400), Ketjenblack® EC 600 JD, (3.00 g), and titanium(IV) isopropoxide, (0.1175 g). The reaction mixture was stirred and heated to 180° C. under a slow nitrogen purge. After achieving 180° C., the resulting reaction mixture was stirred at 180° C. for 0.4 hours while under a slow nitrogen purge. The reaction mixture was then stirred and heated to 190° C. over 0.2 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.3 hours while under a slow nitrogen purge. After achieving 200° C., the resulting reaction mixture was stirred at 200° C. for 0.6 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.5 hours while under a slow nitrogen purge. The reaction mixture was heated to 255° C. over 0.4 hours with stirring under a slow nitrogen purge. The resulting reaction mixture was stirred at 255° C. under a slight nitrogen purge for 0.7 hours. 17.7 g of a colorless distillate was collected over this heating cycle. The reaction mixture was then staged to full vacuum with stirring at 255° C. The resulting reaction mixture was stirred for 2.6 hours under full vacuum, (pressure less than 100 mtorr). The vacuum was then released with nitrogen and the reaction mass allowed to cool to room temperature. An additional 6.7 g of distillate was recovered and 131.1 g of a solid product was recovered.

The sample had an LRV of 17.83 and an IV of 0.57 dL/g.

DSC analysis. A recrystallization temperature was found on the programmed cool after the first heat cycle with an onset at 173.3° C. and a peak at 168.2° C., (28.5 J/g). A crystalline Tm was observed at 197.7° C., (32.7 J/g).

### Example 10

To a 250 milliliter glass flask was added dimethyl terephthalate, (64.55 g), 1,4-butanediol, (38.94 g), poly(tetramethylene ether)glycol, (73.13 g, average molecular weight of 1400), Ketjenblack® EC 600 JD, (3.75 g), and titanium(IV) isopropoxide, (0.1172 g). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.2 hours while under a slow nitrogen purge. After achieving 190° C., the resulting reaction mixture was stirred at 190° C. for 0.6 hours while under a slow nitrogen purge. The reaction mixture was then stirred and heated to 200° C. over 0.4 hours while under a slow nitrogen purge. After achieving 200° C., the resulting reaction mixture was stirred at 200° C. for 0.5 hours while under a slow nitrogen purge. The reaction mixture was then stirred and heated to 225° C. over 0.4 hours while under a slow nitrogen purge. After achieving 225° C., the resulting reaction mixture was stirred at 225° C. for 0.5 hours while under a slow nitrogen purge. The reaction mixture was heated to 255° C. over 0.4 hours with stirring under a slow nitrogen purge. The resulting reaction mixture was stirred at 255° C. under a slight nitrogen purge for 0.5 hours. 18.0 g of a colorless distillate was collected over this heating cycle. The reaction mixture was then staged to full vacuum with stirring at 255° C. The resulting reaction mixture was stirred for 2.0 hours under full vacuum, (pressure less than 100 mtorr). The vacuum was then released with nitrogen and the reaction mass allowed to cool to room temperature. An additional 5.7 g of distillate was recovered and 134.5 g of a solid product was recovered.

The sample had an LRV of 17.16 and an IV of 0.56 dL/g.

DSC analysis. A recrystallization temperature was found on the programmed cool after the first heat cycle with an onset at 174.1° C. and a peak at 169.4° C., (29.9 J/g). A crystalline Tm was observed at 197.5° C., (28.7 J/g).

The surface resistivity was 3.80×10⁴ Ohms per square.

### Example 11

To a 250 milliliter glass flask was added dimethyl terephthalate, (48.00 g), 1,3-propanediol, (19.00 g), poly(ethylene glycol)-block-poly(propylene glycol)-block-poly(ethylene glycol), (59.00 g, average molecular weight of 1100, 10 weight % poly(ethylene glycol), CAS number 9003-11-6), Ketjenblack® EC 600 JD, (3.00 g), and titanium(IV) isopropoxide, (0.1250 g). The reaction mixture was stirred and heated to 180° C. under a slow nitrogen purge. After achieving 180° C., the resulting reaction mixture was stirred at 180° C. for 0.4 hours while under a slow nitrogen purge. The reaction mixture was then stirred and heated to 190° C. over 0.1 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.1 hours while under a slow nitrogen purge. After achieving 200° C., the resulting reaction mixture was stirred at 200° C. for 0.5 hours while under a slow nitrogen purge. The reaction mixture was then stirred and heated to 225° C. over 0.2 hours while under a slow nitrogen purge. After achieving 225° C., the resulting reaction mixture was stirred at 225° C. for 0.9 hours while under a slow nitrogen purge. The reaction mixture was heated to 255° C. over 0.3 hours with stirring under a slow nitrogen purge. The resulting reaction mixture was stirred at 255° C. under a slight nitrogen purge for 0.7 hours. 0.9 g of a colorless distillate was collected over this heating cycle. The reaction mixture was then staged to full vacuum with stirring at 255° C. The resulting reaction mixture was stirred for 3.1 hours under full vacuum, (pressure less than 100 mtorr). The vacuum was then released with nitrogen and the reaction mass allowed to cool to room temperature. An additional 0.7 g of distillate was recovered and 88.9 g of a solid product was recovered.

The sample had an LRV of 15.66 and an IV of 0.53 dL/g.

DSC analysis. A recrystallization temperature was found on the programmed cool after the first heat cycle with an onset at 158.8° C. and a peak at 143.7° C., (16.9 J/g). A crystalline Tm was observed at 207.6° C., (15.0 J/g).

The surface resistivity was 3.15×10³ Ohms per square.

### Example 12

To a 250 milliliter glass flask was added dimethyl terephthalate, (64.22 g), 1,4-butanediol, (38.74 g), poly(tetramethylene ether)glycol, (72.75 g, average molecular weight of 1400), Ketjenblack® EC 600 JD, (4.50 g), and titanium(IV) isopropoxide, (0.1188 g). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.2 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.4 hours while under a slow nitrogen purge. After achieving 200° C., the resulting reaction mixture was stirred at 200° C. for 0.5 hours while under a slow nitrogen purge. The reaction mixture was then stirred and heated to 225° C. over 0.4 hours while under a slow nitrogen purge. After achieving 225° C., the resulting reaction mixture was stirred at 225° C. for 0.5 hours while under a slow nitrogen purge. The reaction mixture was heated to 255° C. over 0.5 hours with stirring under a slow nitrogen purge. The resulting reaction mixture was stirred at 255° C. under a slight nitrogen purge for 0.6 hours. 16.8 g of a colorless distillate was collected over this heating cycle. The reaction mixture was then staged to full vacuum with stirring at 255° C. The resulting reaction mixture was stirred for 2.1 hours under full vacuum, (pressure less than 100 mtorr). The vacuum was then released with nitrogen and the reaction mass allowed to cool to room temperature. An additional 5.6 g of distillate was recovered and 133.9 g of a solid product was recovered.

The sample had an LRV of 16.78 and an IV of 0.55 dL/g.

DSC analysis. A recrystallization temperature was found on the programmed cool after the first heat cycle with an onset at 173.5° C. and a peak at 168.9° C., (27.5 J/g). A crystalline Tm was observed at 196.7° C., (32.9 J/g).

The surface resistivity was 3.75×10³ Ohms per square.

### Example 13

To a 250 milliliter glass flask was added dimethyl terephthalate, (82.10 g), dimethyl isophthalate, (4.32 g), 1,3-propanediol, (44.03 g), poly(ethylene glycol), (4.83 g, average molecular weight of 3400), Ketjenblack® EC 600 JD, (3.50 g), and titanium(IV) isopropoxide, (0.1179 g). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 190° C. over 0.3 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.3 hours while under a slow nitrogen purge. After achieving 200° C., the resulting reaction mixture was stirred at 200° C. for 0.5 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.5 hours while under a slow nitrogen purge. The reaction mixture was heated to 255° C. over 0.5 hours with stirring under a slow nitrogen purge. The resulting reaction mixture was stirred at 255° C. under a slight nitrogen purge for 0.6 hours. 18.4 g of a colorless distillate was collected over this heating cycle. The reaction mixture was then staged to full vacuum with stirring at 255° C. The resulting reaction mixture was stirred for 2.3 hours under full vacuum, (pressure less than 100 mtorr). The vacuum was then released with nitrogen and the reaction mass allowed to cool to room temperature. An additional 2.7 g of distillate was recovered and 88.9 g of a solid product was recovered.

The sample had an LRV of 13.48 and an IV of 0.49 dL/g.

DSC analysis. A recrystallization temperature was found on the programmed cool after the first heat cycle with an onset at 177.9° C. and a peak at 168.2° C., (49.6 J/g). A crystalline Tm was observed at 226.3° C., (41.0 J/g).

The surface resistivity was 1.88×10³ Ohms per square.

### Example 14

To a 250 milliliter glass flask was added dimethyl terephthalate, (63.92 g), 1,4-butanediol, (38.58 g), poly(tetramethylene ether)glycol, (72.48 g, average molecular weight of 1400), Ketjenblack® EC 600 JD, (5.40 g), and titanium(IV) isopropoxide, (0.1280 g). The reaction mixture was stirred and heated to 180° C. under a slow nitrogen purge. After achieving 180° C., the resulting reaction mixture was stirred at 180° C. for 0.7 hours while under a slow nitrogen purge. The reaction mixture was then stirred and heated to 190° C. over 0.1 hours while under a slow nitrogen purge. After achieving 190° C., the resulting reaction mixture was stirred at 190° C. for 0.6 hours while under a slow nitrogen purge. The reaction mixture was then stirred and heated to 200° C. over 0.1 hours while under a slow nitrogen purge. After achieving 200° C., the resulting reaction mixture was stirred at 200° C. for 0.6 hours while under a slow nitrogen purge. The reaction mixture was then stirred and heated to 225° C. over 0.2 hours while under a slow nitrogen purge. After achieving 225° C., the resulting reaction mixture was stirred at 225° C. for 0.6 hours while under a slow nitrogen purge. The reaction mixture was heated to 255° C. over 0.3 hours with stirring under a slow nitrogen purge. The resulting reaction mixture was stirred at 255° C. under a slight nitrogen purge for 0.6 hours. 13.5 g of a colorless distillate was collected over this heating cycle. The reaction mixture was then staged to full vacuum with stirring at 255° C. The resulting reaction mixture was stirred for 0.8 hours under full vacuum, (pressure less than 100 mtorr). The vacuum was then released with nitrogen and the reaction mass allowed to cool to room temperature. An additional 4.5 g of distillate was recovered and 122.9 g of a solid product was recovered.

The sample had an LRV of 32.07 and an IV of 0.83 dL/g.

DSC analysis. A recrystallization temperature was found on the programmed cool after the first heat cycle with an onset at 170.7° C. and a peak at 164.8 C, (21.3 J/g). A crystalline Tm was observed at 195.4° C., (15.8 J/g).

The surface resistivity was 4.20×10³ Ohms per square.

### Example 15

To a 250 milliliter glass flask was added dimethyl terephthalate, (42.48 g), 1,4-butanediol, (19.27 g), poly(tetramethylene ether)glycol, (109.00 g, average molecular weight of 2000), Ketjenblack® EC 600 JD, (5.25 g), and titanium(IV) isopropoxide, (0.1320 g). The reaction mixture was stirred and heated to 180° C. under a slow nitrogen purge. After achieving 180° C., the resulting reaction mixture was stirred at 180° C. for 0.7 hours while under a slow nitrogen purge. The reaction mixture was then stirred and heated to 190° C. over 0.2 hours while under a slow nitrogen purge. After achieving 190° C., the resulting reaction mixture was stirred at 190° C. for 0.8 hours while under a slow nitrogen purge. The reaction mixture was then stirred and heated to 200° C. over 0.1 hours while under a slow nitrogen purge. After achieving 200° C., the resulting reaction mixture was stirred at 200° C. for 0.4 hours while under a slow nitrogen purge. The reaction mixture was then stirred and heated to 225° C. over 0.2 hours while under a slow nitrogen purge. After achieving 225° C., the resulting reaction mixture was stirred at 225° C. for 0.5 hours while under a slow nitrogen purge. The reaction mixture was heated to 255° C. over 0.2 hours with stirring under a slow nitrogen purge. The resulting reaction mixture was stirred at 255° C. under a slight nitrogen purge for 0.7 hours. 6.5 g of a colorless distillate was collected over this heating cycle. The reaction mixture was then staged to full vacuum with stirring at 255° C. The resulting reaction mixture was stirred for 0.8 hours under full vacuum, (pressure less than 100 mtorr). The vacuum was then released with nitrogen and the reaction mass allowed to cool to room temperature. 120.5 g of a solid product was recovered.

The sample had an LRV of 48.56 and an IV of 1.12 dL/g.

DSC analysis. A crystalline Tm was not observed.

The surface resistivity was 9.52×10⁴ Ohms per square.

### Comparative Example CE 1

To a 250 milliliter glass flask was added dimethyl terephthalate, (63.56 g), 1,4-butanediol, (38.40 g), poly(tetramethylene ether)glycol, (72.34 g, average molecular weight of 1400), Ketjenblack® EC 600 JD, (6.12 g), and titanium(IV) isopropoxide, (0.1930 g). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 190° C. over 0.1 hours while under a slow nitrogen purge. After achieving 190° C., the resulting reaction mixture was stirred at 190° C. for 0.4 hours while under a slow nitrogen purge. The reaction mixture was then stirred and heated to 200° C. over 0.2 hours while under a slow nitrogen purge. After achieving 200° C., the resulting reaction mixture was stirred at 200° C. for 0.6 hours while under a slow nitrogen purge. The reaction mixture was then stirred and heated to 222° C. over 0.4 hours while under a slow nitrogen purge. After achieving 222° C., the resulting reaction mixture was observed to be very thick and had wrapped around the stirrer. No material was observed to be stirring. The reaction was shutdown at this point.

### Example 16

To a 250 milliliter glass flask, bis(2-hydroxyethyl)terephthalate, (162.87 g), poly(ethylene glycol)-block-poly(propylene glycol)-block-poly(ethylene glycol), (22.50 g, average molecular weight of 2000, 10 wt % ethylene glycol, CAS Number 9003-11-6), Printex® XE-2 carbon black, (4.50 g), manganese(II) acetate tetrahydrate, (0.0669 g), and antimony(III) trioxide, (0.0539 g) were added. The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.5 hours while under a slow nitrogen purge. The reaction mixture was heated to 295° C. over 1.1 hours with stirring under a slow nitrogen purge. The resulting reaction mixture was stirred at 295° C. under a slight nitrogen purge for 0.6 hours. 28.2 g of a colorless distillate was collected over this heating cycle. The reaction mixture was then staged to full vacuum with stirring at 295° C. The resulting reaction mixture was stirred for 2.6 hours under full vacuum, (pressure less than 100 mtorr). The vacuum was then released with nitrogen and the reaction mass allowed to cool to room temperature. An additional 14.2 g of distillate was recovered and 139.8 g of a solid product was recovered.

The sample had an LRV of 7.61 and an IV of 0.38 dL/g.

DSC analysis. A recrystallization temperature was found on the programmed cool after the first heat cycle with an onset at 211.8° C. and a peak at 207.9° C., (37.0 J/g). A crystalline Tm was observed at 243.4° C., (34.6 J/g).

The surface resistivity was 9.47×10⁴ Ohms per square.

### Example 17

To a 250 milliliter glass flask, bis(2-hydroxyethyl)terephthalate, (162.87 g), poly(ethylene glycol)-block-poly(propylene glycol)-block-poly(ethylene glycol), (22.50 g, average molecular weight of 2000, 10 wt % ethylene glycol, CAS Number 9003-11-6), a ball milled dispersion of 5.88 weight % Printex® XE-2 carbon black and 0.7 weight % polyvinylpyrrolidone, (76.53 g, supplied as Aquablak® 6024 from the Solution Dispersions Company), manganese(II) acetate tetrahydrate, (0.0669 g), and antimony(III) trioxide, (0.0539 g) were added. The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.5 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.7 hours. 100.0 g of a colorless distillate was collected over this heating cycle. The reaction mixture was then staged to full vacuum with stirring at 295° C. The resulting reaction mixture was stirred for 3.3 hours under full vacuum, (pressure less than 100 mtorr). The vacuum was then released with nitrogen and the reaction mass allowed to cool to room temperature. An additional 13.5 g of distillate was recovered and 134.2 g of a solid product was recovered.

The sample had an LRV of 8.66 and an IV of 0.40 dL/g.

DSC analysis. A recrystallization temperature was found on the programmed cool after the first heat cycle with an onset at 210.7° C. and a peak at 206.8° C., (43.0 J/g). A crystalline Tm was observed at 242.3° C., (43.4 J/g).

The surface resistivity was 6.96×10⁴ Ohms per square.

### Example 18

To a 250 milliliter glass flask was added dimethyl terephthalate, (64.00 g), 1,4-butanediol, (38.34 g), poly(tetramethylene ether)glycol, (72.00 g, average molecular weight of 2000), Printex® XE-2 carbon black, (6.15 g), and titanium(IV) isopropoxide, (0.130 g). The reaction mixture was stirred and heated to 180° C. under a slow nitrogen purge. After achieving 180° C., the resulting reaction mixture was stirred at 180° C. for 0.4 hours while under a slow nitrogen purge. The reaction mixture was then stirred and heated to 190° C. over 0.1 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.1 hours while under a slow nitrogen purge. After achieving 200° C., the resulting reaction mixture was stirred at 200° C. for 0.3 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.6 hours while under a slow nitrogen purge. The reaction mixture was heated to 255° C. over 0.4 hours with stirring under a slow nitrogen purge. The resulting reaction mixture was stirred at 255° C. under a slight nitrogen purge for 0.6 hours. 13.1 g of a colorless distillate was collected over this heating cycle. The reaction mixture was then staged to full vacuum with stirring at 255° C. The resulting reaction mixture was stirred for 0.9 hours under full vacuum, (pressure less than 100 mtorr). The vacuum was then released with nitrogen and the reaction mass allowed to cool to room temperature. An additional 1.3 g of distillate was recovered and 120.0 g of a solid product was recovered.

The sample had an LRV of 22.24 and an IV of 0.65 dL/g.

DSC analysis. A recrystallization temperature was found on the programmed cool after the first heat cycle with an onset at 189.3° C. and a peak at 185.5° C., (17.9 J/g). A crystalline Tm was observed at 207.4° C., (15.4 J/g).

The surface resistivity was 7.52×10³ Ohms per square.

### Example 19

To a 250 milliliter glass flask was added dimethyl terephthalate, (47.00 g), 1,3-propanediol, (19.00 g), poly(ethylene glycol)-block-poly(propylene glycol)-block-poly(ethylene glycol), (59.00 g, average molecular weight of 1100, CAS Number 9003-11-6), Ketjenblack® EC 300 J, (2.50 g), and titanium(IV) isopropoxide, (0.1350 g). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.2 hours while under a slow nitrogen purge. After achieving 190° C., the resulting reaction mixture was stirred at 190° C. for 0.7 hours while under a slow nitrogen purge. The reaction mixture was then stirred and heated to 200° C. over 0.2 hours while under a slow nitrogen purge. After achieving 200° C., the resulting reaction mixture was stirred at 200° C. for 0.8 hours while under a slow nitrogen purge. The reaction mixture was then stirred and heated to 225° C. over 0.4 hours while under a slow nitrogen purge. After achieving 225° C., the resulting reaction mixture was stirred at 225° C. for 0.5 hours while under a slow nitrogen purge. The reaction mixture was heated to 255° C. over 0.4 hours with stirring under a slow nitrogen purge. The resulting reaction mixture was stirred at 255° C. under a slight nitrogen purge for 0.9 hours. 4.4 g of a colorless distillate was collected over this heating cycle. The reaction mixture was then staged to full vacuum with stirring at 255° C. The resulting reaction mixture was stirred for 3.2 hours under full vacuum, (pressure less than 100 mtorr). The vacuum was then released with nitrogen and the reaction mass allowed to cool to room temperature. An additional 0.4 g of distillate was recovered and 90.6 g of a solid product was recovered.

The sample had an LRV of 26.36 and an IV of 0.73 dL/g.

DSC analysis. A recrystallization temperature was found on the programmed cool after the first heat cycle with an onset at 157.2° C. and a peak at 143.6° C., (19.3 J/g). A crystalline Tm was observed at 204.2° C., (17.8 J/g).

The surface resistivity was 2.99×10⁶ Ohms per square.

### Example 20

To a 250 milliliter glass flask was added dimethyl terephthalate, (64.22 g), 1,4-butanediol, (38.74 g), poly(tetramethylene ether)glycol, (72.75 g, average molecular weight of 1400), Ketjenblack® EC 300 J, (4.50 g), and titanium(IV) isopropoxide, (0.1175 g). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.2 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.3 hours while under a slow nitrogen purge. After achieving 200° C., the resulting reaction mixture was stirred at 200° C. for 0.6 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.6 hours while under a slow nitrogen purge. The reaction mixture was heated to 255° C. over 0.4 hours with stirring under a slow nitrogen purge. The resulting reaction mixture was stirred at 255° C. under a slight nitrogen purge for 0.5 hours. 16.6 g of a colorless distillate was collected over this heating cycle. The reaction mixture was then staged to full vacuum with stirring at 255° C. The resulting reaction mixture was stirred for 2.7 hours under full vacuum, (pressure less than 100 mtorr). The vacuum was then released with nitrogen and the reaction mass allowed to cool to room temperature. An additional 8.0 g of distillate was recovered and 131.1 g of a solid product was recovered.

The sample had an LRV of 19.22 and an IV of 0.59 dL/g.

DSC analysis. A recrystallization temperature was found on the programmed cool after the first heat cycle with an onset at 173.9° C. and a peak at 168.0° C., (28.7 J/g). A crystalline Tm was observed at 197.5° C., (28.2 J/g).

The surface resistivity was 2.55×10⁴ Ohms per square.

### Example 21

To a 250 milliliter glass flask was added dimethyl terephthalate, (42.00 g), 1,4-butanediol, (19.27 g), poly(tetramethylene ether)glycol, (108.56 g, average molecular weight of 2000), Ketjenblack® EC 300 J, (5.25 g), and titanium(IV) isopropoxide, (0.1390 g). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.1 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.1 hours while under a slow nitrogen purge. After achieving 200° C., the resulting reaction mixture was stirred at 200° C. for 0.6 hours while under a slow nitrogen purge. The reaction mixture was then stirred and heated to 225° C. over 0.2 hours while under a slow nitrogen purge. After achieving 225° C., the resulting reaction mixture was stirred at 225° C. for 0.6 hours while under a slow nitrogen purge. The reaction mixture was heated to 255° C. over 0.3 hours with stirring under a slow nitrogen purge. The resulting reaction mixture was stirred at 255° C. under a slight nitrogen purge for 0.7 hours. 4.9 g of a colorless distillate was collected over this heating cycle. The reaction mixture was then staged to full vacuum with stirring at 255° C. The resulting reaction mixture was stirred for 1.3 hours under full vacuum, (pressure less than 100 mtorr). The vacuum was then released with nitrogen and the reaction mass allowed to cool to room temperature. 137.6 g of a solid product was recovered.

The sample had an LRV of 49.27 and an IV of 1.14 dL/g.

DSC analysis. A crystalline Tm was not observed.

The surface resistivity was 1.06×10⁶ Ohms per square.

### Example 22

To a 500 milliliter glass flask, bis(2-hydroxyethyl)terephthalate, (166.85 g), poly(ethylene glycol), (18.00 g, average molecular weight=1500), a ball milled dispersion of 8.0 weight % Ketjenblack® EC 300 J and 0.7 weight % polyvinyl pyrrolidone in ethylene glycol, (75.00 g, provided as Aquablak® 6071 from Solution Dispersions, Inc.), manganese(II) acetate tetrahydrate, (0.0669 g), and antimony(III) trioxide, (0.0539 g) were added. The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.4 hours while under a slow nitrogen purge. After achieving 225° C., the resulting reaction mixture was stirred at 225° C. for 0.5 hours while under a slow nitrogen purge. The reaction mixture was heated to 295° C. over 0.7 hours with stirring under a slow nitrogen purge. The resulting reaction mixture was stirred at 295° C. under a slight nitrogen purge for 0.7 hours. 95.4 g of a colorless distillate was collected over this heating cycle. The reaction mixture was then staged to full vacuum with stirring at 295° C. The resulting reaction mixture was stirred for 2.6 hours under full vacuum, (pressure less than 100 mtorr). The vacuum was then released with nitrogen and the reaction mass allowed to cool to room temperature. An additional 14.0 g of distillate was recovered and 130.8 g of a solid product was recovered.

The sample had an LRV of 20.76 and an IV of 0.62 dL/g.

DSC analysis. A recrystallization temperature was found on the programmed cool after the first heat cycle with an onset at 206.2° C. and a peak at 200.9° C., (38.6 J/g). A crystalline Tm was observed at 242.1° C., (40.1 J/g).

The surface resistivity was 1.90×10⁵ Ohms per square.

### Example 23

To a 500 milliliter glass flask, bis(2-hydroxyethyl)terephthalate, (166.85 g), poly(ethylene glycol), (18.00 g, average molecular weight=1500), Ketjenblack® EC 300 J, (6.00 g), manganese(II) acetate tetrahydrate, (0.0669 g), and antimony(III) trioxide, (0.0539 g). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.5 hours while under a slow nitrogen purge. The reaction mixture was heated to 295° C. over 0.9 hours with stirring under a slow nitrogen purge. The resulting reaction mixture was stirred at 295° C. under a slight nitrogen purge for 0.8 hours. 25.5 g of a colorless distillate was collected over this heating cycle. The reaction mixture was then staged to full vacuum with stirring at 295° C. The resulting reaction mixture was stirred for 3.6 hours under full vacuum, (pressure less than 100 mtorr). The vacuum was then released with nitrogen and the reaction mass allowed to cool to room temperature. An additional 14.1 g of distillate was recovered and 135.0 g of a solid product was recovered.

The sample had an LRV of 9.76 and an IV of 0.42 dL/g.

DSC analysis. A recrystallization temperature was found on the programmed cool after the first heat cycle with an onset at 208.9° C. and a peak at 203.6° C., (38.6 J/g). A crystalline Tm was observed at 247.0° C., (57.3 J/g).

The surface resistivity was 1.35×10⁴ Ohms per square.

### Example 24

To a 250 milliliter glass flask was added dimethyl terephthalate, (63.55 g), 1,4-butanediol, (38.34 g), poly(tetramethylene ether)glycol, (72.00 g, average molecular weight of 1400), Ketjenblack® EC 300 J, (6.00 g), and titanium(IV) isopropoxide, (0.1176 g). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.2 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.3 hours while under a slow nitrogen purge. After achieving 200° C., the resulting reaction mixture was stirred at 200° C. for 0.5 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.6 hours while under a slow nitrogen purge. The reaction mixture was heated to 255° C. over 0.5 hours with stirring under a slow nitrogen purge. The resulting reaction mixture was stirred at 255° C. under a slight nitrogen purge for 0.6 hours. 15.5 g of a colorless distillate was collected over this heating cycle. The reaction mixture was then staged to full vacuum with stirring at 255° C. The resulting reaction mixture was stirred for 3.1 hours under full vacuum, (pressure less than 100 mtorr). The vacuum was then released with nitrogen and the reaction mass allowed to cool to room temperature. An additional 9.2 g of distillate was recovered and 132.8 g of a solid product was recovered.

The sample had an LRV of 13.66 and an IV of 0.49 dL/g.

DSC analysis. A recrystallization temperature was found on the programmed cool after the first heat cycle with an onset at 175.4° C. and a peak at 170.1° C., (26.8 J/g). A crystalline Tm was observed at 199.8° C., (27.4 J/g).

The surface resistivity was 8.00×10³ Ohms per square.

### Example 25

To a 250 milliliter glass flask was added dimethyl terephthalate, (61.24 g), 1,4-butanediol, (36.94 g), poly(tetramethylene ether)glycol, (69.38 g, average molecular weight of 1400), Ketjenblack® EC 300 J, (11.25 g), and titanium(IV) isopropoxide, (0.1207 g). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 190° C. over 0.2 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.2 hours while under a slow nitrogen purge. After achieving 200° C., the resulting reaction mixture was stirred at 200° C. for 0.5 hours while under a slow nitrogen purge. The reaction mixture was then stirred and heated to 225° C. over 0.4 hours while under a slow nitrogen purge. After achieving 225° C., the resulting reaction mixture was stirred at 225° C. for 0.5 hours while under a slow nitrogen purge. The reaction mixture was heated to 255° C. over 0.5 hours with stirring under a slow nitrogen purge. The resulting reaction mixture was stirred at 255° C. under a slight nitrogen purge for 0.6 hours. 15.2 g of a colorless distillate was collected over this heating cycle. The reaction mixture was then staged to full vacuum with stirring at 255° C. The resulting reaction mixture was stirred for 1.9 hours under full vacuum, (pressure less than 100 mtorr). The vacuum was then released with nitrogen and the reaction mass allowed to cool to room temperature. An additional 6.7 g of distillate was recovered and 126.7 g of a solid product was recovered.

The sample had an LRV of 16.30 and an IV of 0.54 dL/g.

DSC analysis. A recrystallization temperature was found on the programmed cool after the first heat cycle with an onset at 172.7° C. and a peak at 167.0° C., (24.9 J/g). A crystalline Tm was observed at 196.7° C., (32.6 J/g).

The surface resistivity was 1.45×10³ Ohms per square ranging to less than 1.00×10³ Ohms per square.

### Example 26

To a 250 milliliter glass flask was added dimethyl terephthalate, (59.58 g), 1,4-butanediol, (35.95 g), poly(tetramethylene ether)glycol, (67.50 g, average molecular weight of 1400), Ketjenblack® EC 300 J, (15.00 g), and titanium(IV) isopropoxide, (0.1188 g). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 190° C. over 0.3 hours while under a slow nitrogen purge. After achieving 190° C., the resulting reaction mixture was stirred at 190° C. for 0.6 hours while under a slow nitrogen purge. The reaction mixture was then stirred and heated to 200° C. over 0.3 hours while under a slow nitrogen purge. After achieving 200° C., the resulting reaction mixture was stirred at 200° C. for 0.5 hours while under a slow nitrogen purge. The reaction mixture was heated to 255° C. over 0.9 hours with stirring under a slow nitrogen purge. The resulting reaction mixture was stirred at 255° C. under a slight nitrogen purge for 0.6 hours. 14.7 g of a colorless distillate was collected over this heating cycle. The reaction mixture was then staged to full vacuum with stirring at 255° C. The resulting reaction mixture was stirred for 1.6 hours under full vacuum, (pressure less than 100 mtorr). The vacuum was then released with nitrogen and the reaction mass allowed to cool to room temperature. An additional 6.6 g of distillate was recovered and 129.3 g of a solid product was recovered.

The sample had an LRV of 28.80 and an IV of 0.77 dL/g.

DSC analysis. A recrystallization temperature was found on the programmed cool after the first heat cycle with an onset at 172.6° C. and a peak at 168.0° C., (22.6 J/g). A crystalline Tm was observed at 193.9° C., (20.3 J/g).

The surface resistivity was less than 1.0×10³ Ohms per square.

### Example 27

To a 250 milliliter glass flask, bis(2-hydroxyethyl)terephthalate, (177.00 g), poly(tetramethylene ether)glycol, (7.50 g, average molecular weight=2000), Vulcan® XC-72 carbon black, (9.00 g), manganese(II) acetate tetrahydrate, (0.0681 g), and antimony(III) trioxide, (0.0541 g) were added. The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.6 hours while under a slow nitrogen purge. The reaction mixture was heated to 295° C. over 0.6 hours with stirring under a slow nitrogen purge. The resulting reaction mixture was stirred at 295° C. under a slight nitrogen purge for 0.6 hours. 27.0 g of a colorless distillate was collected over this heating cycle. The reaction mixture was then staged to full vacuum with stirring at 295° C. The resulting reaction mixture was stirred for 1.4 hours under full vacuum, (pressure less than 100 mtorr). The vacuum was then released with nitrogen and the reaction mass allowed to cool to room temperature. An additional 15.5 g of distillate was recovered and 142.4 g of a solid product was recovered.

The sample had an LRV of 15.06 and an IV of 0.52 dL/g.

DSC analysis. A recrystallization temperature was found on the programmed cool after the first heat cycle with an onset at 211.3° C. and a peak at 207.6° C., (39.7 J/g). A crystalline Tm was observed at 247.2° C., (35.0 J/g).

The surface resistivity was 3.12×10⁵ Ohms per square.

### Example 28

To a 500 milliliter glass flask, bis(2-hydroxyethyl)terephthalate, (176.78 g), poly(tetramethylene ether) glycol, (7.50 g, average molecular weight=2000), a ball milled dispersion of 10.88 weight % Vulcan® XC-72 and 0.7 weight % polyvinyl pyrrolidone in ethylene glycol, (82.72 g, provided as Aquablak® 6027 from Solution Dispersions, Inc.), manganese(II) acetate tetrahydrate, (0.0669 g), and antimony(III) trioxide, (0.0539 g) were added. The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.6 hours while under a slow nitrogen purge. The reaction mixture was heated to 295° C. over 1.1 hours with stirring under a slow nitrogen purge. The resulting reaction mixture was stirred at 295° C. under a slight nitrogen purge for 0.7 hours. 84.2 g of a colorless distillate was collected over this heating cycle. The reaction mixture was then staged to full vacuum with stirring at 295° C. The resulting reaction mixture was stirred for 3.6 hours under full vacuum, (pressure less than 100 mtorr). The vacuum was then released with nitrogen and the reaction mass allowed to cool to room temperature. An additional 15.8 g of distillate was recovered and 137.7 g of a solid product was recovered.

The sample had an LRV of 17.17 and an IV of 0.56 dL/g.

DSC analysis. A recrystallization temperature was found on the programmed cool after the first heat cycle with an onset at 199.4° C. and a peak at 194.6° C., (40.6 J/g). A crystalline Tm was observed at 240.4° C., (37.3 J/g).

The surface resistivity was 2.75×10⁷ Ohms per square.

### Example 29

To a 250 milliliter glass flask was added dimethyl terephthalate, (44.91 g), 1,3-propanediol, (17.87 g), poly(ethylene glycol)-block-poly(propylene glycol)-block-poly(ethylene glycol), (55.80 g, average molecular weight of 1100, CAS Number 9003-11-6), Vulcan® XC-72, (7.00 g), and titanium(IV) isopropoxide, (0.1198 g). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 190° C. over 0.3 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.2 hours while under a slow nitrogen purge. After achieving 200° C., the resulting reaction mixture was stirred at 200° C. for 0.6 hours while under a slow nitrogen purge. The reaction mixture was then stirred and heated to 225° C. over 0.4 hours while under a slow nitrogen purge. After achieving 225° C., the resulting reaction mixture was stirred at 225° C. for 0.5 hours while under a slow nitrogen purge. The reaction mixture was heated to 255° C. over 0.5 hours with stirring under a slow nitrogen purge. The resulting reaction mixture was stirred at 255° C. under a slight nitrogen purge for 0.6 hours. 7.1 g of a colorless distillate was collected over this heating cycle. The reaction mixture was then staged to full vacuum with stirring at 255° C. The resulting reaction mixture was stirred for 3.0 hours under full vacuum, (pressure less than 100 mtorr). The vacuum was then released with nitrogen and the reaction mass allowed to cool to room temperature. An additional 1.0 g of distillate was recovered and 95.2 g of a solid product was recovered.

The sample had an LRV of 22.37 and an IV of 0.65 dL/g.

DSC analysis. A recrystallization temperature was found on the programmed cool after the first heat cycle with an onset at 126.1° C. and a peak at 112.5° C., (19.7 J/g). A crystalline Tm was observed at 176.5° C., (16.6 J/g).

The surface resistivity was 1.90×10⁵ Ohms per square.

### Example 30

To a 250 milliliter glass flask was added dimethyl terephthalate, (61.00 g), 1,4-butanediol, (37.00 g), poly(tetramethylene ether)glycol, (70.00 g, average molecular weight of 1400), Vulcan® XC-72 carbon black, (11.00 g), and titanium(IV) isopropoxide, (0.120 g). The reaction mixture was stirred and heated to 180° C. under a slow nitrogen purge. After achieving 180° C., the resulting reaction mixture was stirred at 180° C. for 0.4 hours while under a slow nitrogen purge. The reaction mixture was then stirred and heated to 190° C. over 0.2 hours while under a slow nitrogen purge. After achieving 190° C., the resulting reaction mixture was stirred at 190° C. for 0.4 hours while under a slow nitrogen purge. The reaction mixture was then stirred and heated to 225° C. over 0.5 hours while under a slow nitrogen purge. After achieving 225° C., the resulting reaction mixture was stirred at 225° C. for 1.3 hours while under a slow nitrogen purge. The reaction mixture was heated to 255° C. over 0.4 hours with stirring under a slow nitrogen purge. The resulting reaction mixture was stirred at 255° C. under a slight nitrogen purge for 0.5 hours. 13.9 g of a colorless distillate was collected over this heating cycle. The reaction mixture was then staged to full vacuum with stirring at 255° C. The resulting reaction mixture was stirred for 1.3 hours under full vacuum, (pressure less than 100 mtorr). The vacuum was then released with nitrogen and the reaction mass allowed to cool to room temperature. An additional 4.9 g of distillate was recovered and 118.6 g of a solid product was recovered.

The sample had an LRV of 17.48 and an IV of 0.56 dL/g.

DSC analysis. A recrystallization temperature was found on the programmed cool after the first heat cycle with an onset at 166.7° C. and a peak at 161.9° C., (24.2 J/g). A crystalline Tm was observed at 192.6° C., (24.4 J/g).

The surface resistivity was 6.19×10⁵ Ohms per square.

### Example 31

To a 250 milliliter glass flask was added dimethyl terephthalate, (78.27 g), dimethyl isophthalate, (4.12 g), 1,3-propanediol, (41.97 g), poly(ethylene glycol), (4.60 g, average molecular weight of 3400), Vulcan® XC-72, (8.00 g), and titanium(IV) isopropoxide, (0.1171 g). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.2 hours while under a slow nitrogen purge. After achieving 190° C., the resulting reaction mixture was stirred at 190° C. for 0.6 hours while under a slow nitrogen purge. The reaction mixture was then stirred and heated to 200° C. over 0.3 hours while under a slow nitrogen purge. After achieving 200° C., the resulting reaction mixture was stirred at 200° C. for 0.6 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.6 hours while under a slow nitrogen purge. The reaction mixture was heated to 255° C. over 0.5 hours with stirring under a slow nitrogen purge. The resulting reaction mixture was stirred at 255° C. under a slight nitrogen purge for 0.6 hours. 18.6 g of a colorless distillate was collected over this heating cycle. The reaction mixture was then staged to full vacuum with stirring at 255° C. The resulting reaction mixture was stirred for 2.7 hours under full vacuum, (pressure less than 100 mtorr). The vacuum was then released with nitrogen and the reaction mass allowed to cool to room temperature. An additional 4.3 g of distillate was recovered and 89.7 g of a solid product was recovered.

The sample had an LRV of 26.57 and an IV of 0.73 dL/g.

DSC analysis. A recrystallization temperature was found on the programmed cool after the first heat cycle with an onset at 152.9° C. and a peak at 141.5° C., (42.4 J/g). A crystalline Tm was observed at 222.1° C., (39.4 J/g).

The surface resistivity was 7.45×10⁵ Ohms per square.

### Example 32

To a 250 milliliter glass flask was added dimethyl terephthalate, (59.58 g), 1,4-butanediol, (35.95 g), poly(tetramethylene ether)glycol, (67.50 g, average molecular weight of 1400), Vulcan® XC-72, (15.00 g), and titanium(IV) isopropoxide, (0.1206 g). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.3 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.3 hours while under a slow nitrogen purge. After achieving 200° C., the resulting reaction mixture was stirred at 200° C. for 0.6 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.5 hours while under a slow nitrogen purge. The reaction mixture was heated to 255° C. over 0.3 hours with stirring under a slow nitrogen purge. The resulting reaction mixture was stirred at 255° C. under a slight nitrogen purge for 0.8 hours. 17.9 g of a colorless distillate was collected over this heating cycle. The reaction mixture was then staged to full vacuum with stirring at 255° C. The resulting reaction mixture was stirred for 2.0 hours under full vacuum, (pressure less than 100 mtorr). The vacuum was then released with nitrogen and the reaction mass allowed to cool to room temperature. An additional 6.5 g of distillate was recovered and 106.2 g of a solid product was recovered.

The sample had an LRV of 25.63 and an IV of 0.71 dL/g.

DSC analysis. A recrystallization temperature was found on the programmed cool after the first heat cycle with an onset at 166.0° C. and a peak at 161.6° C., (25.3 J/g). A crystalline Tm was observed at 191.5° C., (27.6 J/g).

### Example 33

To a 250 milliliter glass flask, bis(2-hydroxyethyl)terephthalate, (113.22 g), poly(ethylene glycol), (12.00 g, average molecular weight=1500), a ball milled dispersion of 8.0 weight % Ketjenblack® EC 300 J and 0.7 weight % polyvinyl pyrrolidone in ethylene glycol, (25.00 g, provided as Aquablak® 6071 from Solution Dispersions, Inc.), Ketjenblack® EC 600 JD, (0.50 g), manganese(II) acetate tetrahydrate, (0.0446 g), and antimony(III) trioxide, (0.0359 g) were added. The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.6 hours while under a slow nitrogen purge. The reaction mixture was heated to 295° C. over 0.9 hours with stirring under a slow nitrogen purge. The resulting reaction mixture was stirred at 295° C. under a slight nitrogen purge for 0.5 hours. 40.2 g of a colorless distillate was collected over this heating cycle. The reaction mixture was then staged to full vacuum with stirring at 295° C. The resulting reaction mixture was stirred for 3.5 hours under full vacuum, (pressure less than 100 mtorr). The vacuum was then released with nitrogen and the reaction mass allowed to cool to room temperature. An additional 12.7 g of distillate was recovered and 90.4 g of a solid product was recovered.

The sample had an LRV of 18.10 and an IV of 0.57 dL/g.

DSC analysis. A recrystallization temperature was found on the programmed cool after the first heat cycle with an onset at 298.1° C. and a peak at 203.3° C., (39.9 J/g). A crystalline Tm was observed at 244.3° C., (38.9 J/g).

The surface resistivity was 5.15×10⁴ Ohms per square.

1. A composition comprising carbon black-containing polyetherester, which comprises <about 3.5 weight % of carbon black if the carbon black has a DBP of >about 420 cc/100 g, or ≦about 15 weight % of carbon black if the carbon black has a DBP between about 220 cc/100 g and about 420 cc/100 g or between about 150 cc/100 g and about 210 cc/100 g wherein the carbon black has a nitrogen adsorption surface area measure by ASTM D 3037-81>700 m²/g and the DBP is dibutyl phthalate oil adsorption measured by ASTM D2414-93.

2. The composition of claim 1 wherein the carbon black has a DBP of >about 420 cc/100 g and is present in the carbon black-containing polyetherester in the range of from about 0.5 to about 3.5 or about 1 to about 3.5 weight %.

3. The composition of claim 2 wherein the carbon black has a DBP absorption of between 480 and 520 cc/100 g and a nitrogen adsorption between 1250 and 1270 m²/g.

4. The composition of claim 1 wherein the carbon black has a DBP of from about 220 cc/100 g to about 420 cc/100 g and is present in the carbon black-containing polyetherester in the range of from about 1 to about 10 or about 2 to about 10 weight %.

5. The composition of claim 4 wherein the carbon black has (1) DBP between 350 and 385 cc/100 g and nitrogen adsorption of about 800 m²/g, (2) DBP of 330 cc/100 g and nitrogen adsorption of between about 1475 and about 1635 m²/g), (3) DBP of 380 and 400 cc/100 g and nitrogen adsorption of about 1300 m²/g), or (4) combinations of two or more of (1), (2), and (3); and the carbon black is optionally deagglomerated.

6. The composition of claim 1 wherein the carbon black has a DBP of from about 150 cc/100 g to about 210 cc/100 g and is present in the carbon black-containing polyetherester in the range of from about 2 to about 12.5 or about 6 to about 10 weight %.

7. The composition of claim 6 wherein the carbon black has (1) DBP of about 170 cc/100 g and nitrogen adsorption of about 250 m²/g, (2) DBP between about 78 cc/100 g and about 192 cc/100 g and nitrogen adsorption of about 245 m²/g, or (3) combinations of (1) and (2); and the carbon black is optionally deagglomerated.

8. The composition of claim 1 wherein the carbon black is a combination of two or more of a first carbon black, a second carbon black, and a third carbon black; the first carbon black is present in about 0.1 to about 3.5, about 0.5 to about 3, or about 0.5 to about 2, weight % carbon black having a DBP>about 420 cc/100 g; the second carbon black is present in about 0.1 to about 10, about 0.5 to about 7.5, or about 0.5 to about 5, carbon black having a DBP between about 220 cc/100 g and about 420 cc/100 g; the third carbon black is present in about 1 to about 12.5, about 2 to about 10, or about 2 to about 7.5 carbon black having a DBP between about 150 cc/100 g and about 210 cc/100 g; and the second carbon black, the third carbon black, or both, is optionally deagglomerated.

9. The composition of claim 1 wherein the composition or the carbon black-containing polyetherester further comprises from about 1 to about 40 weight % of a reinforcing agent or about 1 to about 30 weight % of a toughener or both, based on the total weight of the final composition; the reinforcing agent includes glass fiber, natural fiber, carbon fiber, graphite fiber, silica fiber, ceramic fiber, metal fiber, stainless steel fiber, recycled paper fiber, or combinations of two or more thereof; and the toughener includes rubber.

10. The composition of claim 9 wherein the composition or the carbon black-containing polyetherester further comprises the reinforcing agent the rubber.

11. A shaped article comprising or produced from a composition wherein the articles is monofilament, fiber, textile, film, sheet, molded part, foam, polymeric melt extrusion coating onto substrate, polymeric solution coating onto substrate, laminate, container, blown bottle, or combinations of two or more thereof and the composition is as recited in claim 1.

12. The article of claim 11 wherein the composition is as recited in claim 2.

13. The article of claim 11 wherein the composition is as recited in claim 4.

14. The article of claim 11 wherein the composition is as recited in claim 6.

15. The article of claim 11 wherein the composition is as recited in claim 9.

16. A process comprising contacting a mixture with carbon black wherein the mixture comprises at least one dicarboxylic acid, at least one glycol, and at least one poly(alkylene ether)glycol; the carbon black is present in ≦about 3.5 weight % if the carbon black has a DBP of >about 420 cc/100 g or is present in ≦about 15 weight % if the carbon black has a DBP between about 220 cc/100 g and about 420 cc/100 g or between about 150 cc/100 g and about 210 cc/100 g; the weight % is based on total weight of the mixture and carbon black; the DBP is as defined in claim 1; and the carbon black has the same nitrogen adsorption surface as recited in claim 1.

17. The process of claim 16 wherein the contacting produces a carbon black-containing polyetherester; the process further comprises recovering the carbon black-containing polyetherester; and the carbon black-containing polyetherester is as recited in claim 1.

18. The process of claim 17 wherein the carbon black is present in the range of from about 0.5 to about 3.5 or about 1 to about 3.5 weight % if the carbon black has a DBP of >about 420 cc/100 g.

19. The process of claim 17 wherein the carbon black is present in the range of from about 1 to about 10 or about 2 to about 10 weight % if the carbon black has a DBP of from about 220 cc/100 g to about 420 cc/100 g and is optionally de-agglomerated.

20. The process of claim 17 wherein the carbon black is present in the range of from about 2 to about 12.5 or about 6 to about 10 weight % if the carbon black has a DBP of from about 150 cc/100 g to about 210 cc/100 g and is optionally de-agglomerated.

21. The process of claim 17 wherein the carbon black is a combination of two or more of a first carbon black, a second carbon black, and a third carbon black; the first carbon black is present in about 0.1 to about 3.5, about 0.5 to about 3, or about 0.5 to about 2, weight % carbon black having a DBP>about 420 cc/100 g; the second carbon black is present in about 0.1 to about 10, about 0.5 to about 7.5, or about 0.5 to about 5, carbon black having a DBP between about 220 cc/100 g and about 420 cc/100 g; the third carbon black is present in about 1 to about 12.5, about 2 to about 10, or about 2 to about 7.5 carbon black having a DBP between about 150 cc/100 g and about 210 cc/100 g; and at least one of the second carbon black or the third carbon black is deagglomerated.

22. The process of claim 21 wherein the combination includes form 0.5 to 2.0 weight % of the first carbon black, from 0.5 to 5.0 weight % of the second carbon black, and from 2 to 10 weight % of the third carbon black.

23. The process of claim 21 wherein the total weight % of the combination is in the range of 1-15 weight % or 1.5-12.5 weight % or 2-7.5 weight %.
